(19) United States
(12) Patent Application Publication
(10) Pub. No.: US 2006/0097446 A1
(43) Pub. Date: May 11, 2006

(54) Game machine and program

(76) Inventor: Hirobumi Toyoda, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/528,107

(22) PCT Filed: Sep. 8, 2003
(86) PCT No.: PCT/JP03/11441

§ 371 Date: Jul. 27, 2005

(30) Foreign Application Priority Data
Sep. 17, 2002 (JP) 2002-270679

(51) Int. Cl. G07C 15/00; A63F 7/04

(52) U.S. Cl. 273/144 R; 273/144 A; 273/144 B

(57) ABSTRACT

In a gaming machine such as a bingo game, there is provided such a gaming machine that game players are effected with realistic sensations and spectators other than game players are involved. The gaming machine is equipped with lottery ball throwing means for throwing a plurality of balls onto a face portion of a cabinet, ball entrance detecting means for detecting whether all the plurality of lottery balls thrown onto the face portion of the cabinet by the lottery ball throwing means enter a plurality of lottery holes, and lottery ball discharging means for discharging the plurality of lottery balls entering any one of the plurality of lottery holes. When it is detected by the ball entrance detecting means that all the plurality of lottery balls thrown by the lottery ball throwing means enter any one of the plurality of lottery holes, the lottery ball discharging means functions to discharge all the plurality of lottery balls after a predetermined time elapses.

### TECHNICAL FIELD

The present invention relates to a gaming machine and a program.

### BACKGROUND ART

There has been played a bingo game using cards having cells formed in a matrix form thereon, the cells being respectively allocated with various kinds of identification information. According to the bingo game, a cell allocated with identification information selected by lottery or the like is punched, and a game player who most quickly arranges any one of vertical, horizontal and diagonal lines composed of punched cells can win the game.

Unlike a lottery method in which the rule thereof is simple and a result can be instantaneously known, such a bingo game has an effect which causes a game player impatience because it is almost impossible to quickly punch cells and also with such a sense of anticipation that a line of punched cells would be completed if the last one cell is punched, and thus this game has been familiar with many people irrespective of age and sex.

Bingo cards of paper are used in this bingo game, however, various gaming machines imitating this game have been developed.

Out of these games, Japanese Published Unexamined Patent Application No. 2001-162046 discloses such a gaming machine that a lottery ball is thrown onto a face portion and when the ball enters any one of the plurality of holes, identification information displayed on a display portion is activated. This gaming machine effects a game player with such a realistic sensation that a lottery ball enters a lottery hole in front of the eyes of the game player, and thus the players interest in the game can be perpetuated.

According to such a gaming machine, after some lottery ball enters a lottery hole, the lottery ball is afterwards discharged and falls into an invisible state. Therefore, in order for game players to check a lottery result, they rely on only a lottery result on the display portion. Even when the game players visually identify an image representing mere identification information, the game players hardly feel that the entrance of the lottery ball into the lottery hole is real, and thus it is difficult to effect the game players with realistic sensations.

Furthermore, according to the gaming machine as described above, for spectators other then the game players who can gaze at a display portion, only a display portion which is equipped so as to be adapted for some game player is available for allowing the spectators to visually identify identification information selected by lottery.

Furthermore, the spectators can peer at the display portion of some game player. However, not only do the spectators hardly feel that the entrance of the lottery ball into the lottery hole is real, but also it is not an easy action to peer at the display portion of some game player.

### DISCLOSURE OF THE INVENTION

The present invention has been implemented in view of the problem above, and has an object to provide a gaming machine which effects game players with realistic sensations and also involves the spectators other than the game players.

In order to attain the above object, a gaming machine according to the present invention is characterized by comprising: lottery ball throwing means for throwing a plurality of lottery balls onto a face portion of a cabinet; ball entrance detecting means for detecting whether all the plurality of lottery balls thrown onto the face portion of the cabinet enter a plurality of lottery holes by the lottery ball throwing means; and lottery ball discharging means for discharging the plurality of lottery balls which enter the plurality of respective lottery holes, wherein when it is detected that all the plurality of lottery balls thrown by the lottery ball throwing means enter the plurality of respective lottery holes, the lottery ball discharging means functions to discharge all the plurality of lottery balls after a predetermined time elapses.

More specifically, the present invention provides the following.

(1) A gaming machine comprising: a cabinet having a face portion on which a lottery ball rolls and a plurality of lottery holes provided on the face portion, and game result determination means for determining a game result on a basis of each of the plurality of holes receiving a lottery ball under a condition that the lottery ball enters any one of the plurality of lottery holes, further comprising: lottery ball throwing means for throwing a plurality of lottery balls onto the face portion of the cabinet; ball entrance detecting means for detecting whether all the plurality of lottery balls having been thrown onto the face portion of the cabinet by the lottery ball throwing means enter any of the plurality of lottery holes; and lottery ball discharging means for discharging the plurality of lottery balls having entered any of the plurality of lottery holes, wherein the lottery ball discharging means has a function to discharge all the plurality of lottery balls after a predetermined period of time elapses when the ball entrance detecting means detects that all the plurality of lottery balls having been thrown by the lottery ball throwing means enter any of the plurality of respective lottery holes.

As described above, actual lottery balls may be set to be visible to the game players. Accordingly, various information such as the number of lottery balls, lottery holes which lottery balls are being put in, etc., can be visually recognized, and thus there can be provided a game which can effect game players with more realistic sensations.

Furthermore, spectators other than the game players performing the actual game can also visually recognize the various information such as the number of lottery balls, lottery holes which lottery balls are being put in, etc., and thus not only the game players, but also the spectators can enjoy the game. Therefore, there can be provided such a game that a game player may be encouraged to have such a feeling that they are being seen by the spectators, and thus when he/she has a good game result, he/she has such a sense of mastery that he/she is seen by the other game players and the spectators. Furthermore, there can be being provided such a game that a game player has such a sense of anticipation that he/she could achieve a better game result.

(2) The gaming machine according to (1), wherein the lottery ball discharging means has a function to discharge all the plurality of lottery balls after a predetermined period of time elapses when the ball entrance detecting means detects that all the plurality of lottery balls having been thrown by the lottery ball throwing means enter any of the plurality of respective lottery holes.

(3) The gaming machine according to (1) or (2), wherein symbols are allocated to respective cells of a matrix comprising two or more cell numbers of rows and two or more cell numbers of columns, the cell number of the rows are equal to the cell number of cells of the columns, and the respective symbols are allocated to the plurality of respective lottery holes, and wherein, when a lottery ball enters any one of the plurality of lottery holes, the game result determination means has a function to activate a cell corresponding to a symbol allocated to any one of the plurality of lottery holes which the lottery ball enters and to determine a game result in accordance with a distribution condition in the matrix containing cells having been activated as a result of entrance of the lottery ball to any one of the plurality of lottery holes for a predetermined number of times.

(4) The gaming machine according to any one of (1) to (3), wherein the lottery ball discharging means is provided with a shutter which is freely opened/closed on a lower side of any one of the lottery holes, and wherein, when the ball entrance detecting means detects that all of the plurality of lottery balls having been thrown by the lottery ball throwing means enter any of the plurality of lottery holes, the lottery ball discharging means has a function to open the shutter after a predetermined period of time elapses.

As described above, the actual lottery ball may be set to be visible to the game players. Accordingly, various information such as the number of lottery balls, lottery holes which lottery balls are being put in, etc., can be made visible, so that there can be provided such a game that the game players are effected with more realistic sensations.

Furthermore, the spectators other than the game players who actually play the game can also visually recognize the various information such as the number of lottery balls, lottery holes which lottery balls are being put in, etc., and thus not only the game players, but also the spectators can enjoy the game. Accordingly, there can be provided such a game that a game player may be encouraged to have such a feeling that they are being seen by the spectators, and thus when he/she has a good game result, he/she has such a sense of mastery that he/she is being seen by the other game players and the spectators. Furthermore, there can be provided such a game that a game player has such a sense of anticipation that he/she could achieve a better game result.

Still furthermore, there can be provided a gaming machine comprising a face portion on which a lottery ball is rolled, a plurality of lottery holes provided on the face portion so that the lottery ball enters any one of the lottery holes, a sensor for detecting that the lottery ball enters any one of the plurality of lottery holes, and a shutter for holding the lottery ball at the lottery hole which the lottery ball concerned enters, characterized in that a game result is determined on the basis of the lottery hole which the lottery ball enters, and the shutter is opened so that the lottery ball entering the lottery hole which the lottery ball concerned enters is discharged from the lottery hole concerned.

Here, the plurality of lottery holes may be designed to be different from one another in shape, size, position on the face portion and/or property (or inherent information). Accordingly, the difficulty level of entrance of a lottery ball to any one lottery hole may be different or identical among the lottery holes. The sensor for detecting bell entrance is preferably equipped to each lottery hole, however, it may be an external sensor which can identify each of lottery holes while discriminating from one another. The external sensor may be designed to identify entrance of one or more lottery balls. The shutter for holding a lottery ball entering a lottery hole may be located below this lottery hole. Accordingly, the lottery hole is opened to the face portion side at which a lottery ball rolls, and allows the lottery ball to enter the lottery hole. The closed shutter located below the lottery hole can prevent the lottery ball from passing through the lottery hole, whereby it can hold the lottery ball in the lottery hole. When the shutter is opened, the lottery ball can pass through the lottery hole, and is discharged from the lottery hole.

Furthermore, there can be provided a gaming machine comprising a face portion on which a lottery ball is rolled, a plurality of lottery holes provided on the face portion so that a plurality of lottery balls possibly enter the plurality of lottery holes, a sensor provided so as to detect entrance of the plurality of lottery balls into the plurality of lottery holes, and a shutter provided so that each of the plurality of lottery balls is held in each of the plurality of lottery holes, characterized in that a game result is determined on the basis of a combination of the plurality of lottery holes which the plurality of lottery balls enter, and the plurality of lottery balls thus entering are discharged from the plurality of lottery holes by opening the shutter.

Here, the possible entrance of the plurality of lottery balls to the plurality of lottery holes means that each lottery ball enters each lottery hole and also means that one or more lottery holes enter each lottery hole. The shutters equipped to the plurality of lottery holes may be simultaneously or separately opened/closed, and these opening/closing styles of the shutters described above may be suitably selected in accordance with the type of a game to be played. The face portion may be movable equipped, and for example, it may be rotated around the rotational shaft passing through any position of the face portion.

(5) A program for controlling a gaming machine comprising; a cabinet being composed of a face portion on which a lottery ball rolls and a plurality of lottery holes provided on the face portion, game result determination means for determining a game result on a basis of each of the plurality of lottery holes which a lottery ball enters under a condition that the lottery ball enters any one of the plurality of lottery holes, lottery ball throwing means for throwing a plurality of lottery balls onto the face portion of the cabinet, ball entrance detecting means for detecting whether all the plurality of lottery balls having been thrown onto the face portion of the cabinet by the lottery ball throwing means enter any of the plurality of lottery holes, and lottery ball discharging means for discharging the plurality of lottery balls having been thrown by the lottery ball throwing means and having entered any of the plurality of lottery holes, wherein the program makes the gaming machine execute the step that the lottery ball discharging means discharges all the plurality of lottery balls having been thrown by the lottery ball throwing means after a predetermined period of time elapses when it is detected by the ball entrance detecting means that the plurality of lottery balls having been thrown by the lottery ball throwing means enter the plurality of respective lottery holes.

As described above, actual lottery balls may be set to be visually recognized. Accordingly, various information such as the number of lottery balls, lottery holes which lottery balls are being put in, etc., are visually recognized, and thus there can be provided a game which effects game players with more realistic sensations.

Still furthermore, the spectators other than the game players carrying out the actual game can also visually recognize the various information such as the number of lottery balls, lottery holes which lottery balls are being put in, etc., and thus not only the game players, but also the spectators can enjoy the game. Therefore, there can be provided such a game that a game player may be encouraged to have such a feeling that he/she is being seen by the spectators, and thus when he/she has a good game result, he/she has such a sense of mastery that he/she is being seen by the other game players and the spectators. Furthermore, there can be provided such a game that a game player has such a sense of anticipation that he/she could achieve a better game result.

Further detailed features, properties and various advantages according to the present invention will be clear from the following detailed description of the present invention and attached drawings.

### BRIEF DESCRIPTION OF THE DRAWINGS

FIG. 1 is a perspective view showing the general view of a gaming machine according to a preferred embodiment of the present invention.

FIG. 2 is a cross-sectional view showing a sailboat type lottery machine in the gaming machine of FIG. 1.

FIG. 3A is an enlarged view of the vicinity of the lottery board in the gaming machine of FIG. 1.

FIG. 3B is an enlarged view of the lottery board in the gaming machine of FIG. 1.

FIG. 3C is an enlarged cross-sectional view of a lottery hole in the gaming machine of FIG. 1.

FIG. 4A is a plan view showing the vicinity of a lottery ball receiving portion in the gaming machine of FIG. 1.

FIG. 4B is a plan view showing the vicinity of the lottery ball receiving portion in the gaming machine of FIG. 1.

FIG. 5 is an enlarged view showing a part of a personal game operating unit in the gaming machine of FIG. 1.

FIG. 6 is a block diagram showing a circuit construction containing a main control circuit for controlling the gaming machine of FIG. 1 and a peripheral device electrically connected to the main control circuit.

FIG. 7 shows a data sheet for associating codes used in the gaming machine of FIG. 1 with symbols.

FIG. 8 is a block diagram showing a display device of the gaming machine of FIG. 1.

FIG. 9 is a diagram showing a screen display example of the gaming machine of FIG. 1.

FIG. 10 is a diagram showing a screen display example of the gaming machine of FIG. 1.

FIG. 11 is a flowchart showing a control processing example which can be executed in the gaming machine of FIG. 1.

FIG. 12 is a flowchart showing a control processing example which can be executed in the gaming machine of FIG. 1.

FIG. 13 is a flowchart showing a control processing example which can be executed in the gaming machine of FIG. 1.

FIG. 14 is a flowchart showing a control processing example which can be executed in the gaming machine of FIG. 1.

FIG. 15 is a flowchart showing a control processing example which can be executed in the gaming machine of FIG. 1.

FIG. 16 is a flowchart showing a control processing example which can be executed in the gaming machine of FIG. 1.

FIG. 17A is an enlarged view showing a lottery ball waiting portion of the gaming machine of FIG. 1.

FIG. 17B is an enlarged view showing the lottery ball waiting portion of the gaming machine of FIG. 1.

FIG. 17C is an enlarged view showing the lottery ball waiting portion of the gaming machine of FIG. 1.

FIG. 17D is an enlarged view showing the lottery ball waiting portion of the gaming machine of FIG. 1.

FIG. 17E is an enlarged view showing the lottery bell waiting portion of the gaming machine of FIG. 1.

FIG. 17F is an enlarged view showing the lottery ball waiting portion of the gaming machine of FIG. 1.

FIG. 17G is an enlarged view showing the lottery ball waiting portion of the gaming machine of FIG. 1.

FIG. 17H is an enlarged view showing the lottery ball waiting portion of the gaming machine of FIG. 1.

FIG. 17I is an enlarged view showing the lottery ball waiting portion of the gaming machine of FIG. 1.

FIG. 18 is a perspective view showing the general view of a gaming machine according to another preferred embodiment of the present invention.

FIG. 19 is a longitudinally-sectional view showing the general view of a lottery machine of the gaming machine shown in FIG. 18.

FIG. 20 is a top view of a lottery ball receiving portion of the gaming machine of FIG. 18.

FIG. 21 is a top view showing the lottery machine of the gaming machine of FIG. 18.

FIG. 22A is a longitudinally-sectional view showing a second withdrawing passage of the gaming machine of FIG. 18.

FIG. 22B is a longitudinally-sectional view showing the second withdrawing passage of the gaming machine of FIG. 18.

FIG. 22C is a longitudinally-sectional view showing the second withdrawing passage of the gaming machine of FIG. 18.

FIG. 22D is a longitudinally-sectional view showing the second withdrawing passage of the gaming machine of FIG. 18.

FIG. 22E is a longitudinally-sectional view showing the second withdrawing passage of the gaming machine of FIG. 18.

FIG. 22F is a longitudinally-sectional view showing the second withdrawing passage of the gaming machine of FIG. 18.

FIG. 22G is a longitudinally-sectional view showing the second withdrawing passage of the gaming machine of FIG. 18.

### DESCRIPTION OF THE PREFERRED EMBODIMENT

Preferred embodiments according to the present invention will be described hereunder with reference to the accompanying drawings. In these embodiments, a gaming machine of the present invention is applied to a bingo gaming machine.

[Construction of Gaming Machine]

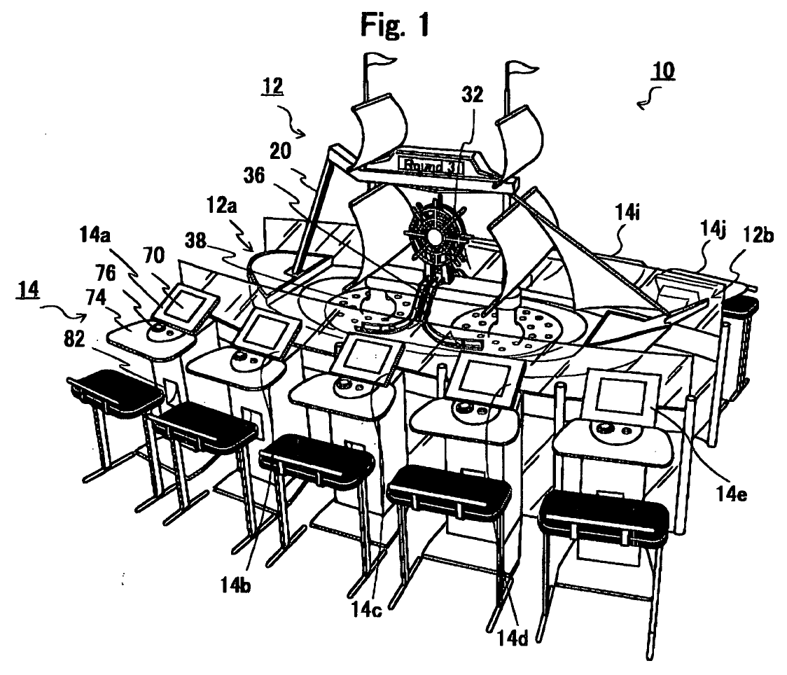

FIG. 1 schematically shows a gaming machine 10 according to this embodiment.

The gaming machine 10 is a gaming machine, with which a plurality of people can play simultaneously, and it is provided with a sailboat type lottery machine 12 at the center thereof. A plurality of game operating units 14 for individuals are provided at both the starboard and portside of the sailboat constituting the sailboat type lottery machine 12. In the embodiment shown in FIG. 1, five personal game operating units 14a to 14j are provided an one side, and thus, ten personal game operating units 14a to 14j in total are provided on both sides. The personal game operating units 14f to 14h are not illustrated in FIG. 1.

<Construction of Sailboat Type Lottery Machine>

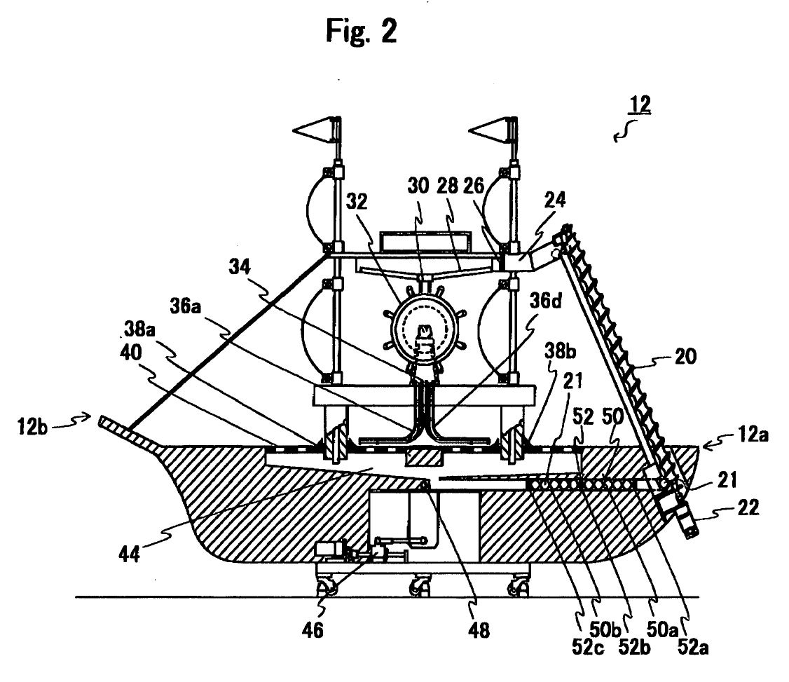

FIG. 2 is a schematic cross-sectional view of the sailboat type lottery machine 12. The sailboat type lottery machine 12 will be described hereunder with reference to FIGS. 1 and 2.

A lottery ball raising device 20 is provided at a stern portion 12a of the sailboat type lottery machine 12, and a spiral groove is provided to the lottery ball raising device 20 so as to have a radius of curvature which is slightly larger than the radius of a lottery ball 21. The lottery ball raising device 20 is rotated by a lottery ball raising motor 22 provided at the lower portion of the lottery ball raising device 20 to raise the lottery ball 21 along the groove.

The lottery ball 21 raised by the lottery ball raising device 20 is fed to a lottery ball standby portion 24 disposed at the upper portion of the sailboat type lottery machine 12. By opening a lottery gate 26 at a predetermined timing, the lottery ball 21 is fed out to the lottery portion of the sailboat type lottery machine 12 one by one.

The lottery ball 21 fed out from the lottery gate 26 rolls on an upper gutter 28, and when it reaches a drop hole 30 provided at the center portion of the upper gutter 28, it drops down to a steering-wheel type rotating device 32. A passage having a circumferential shape through which the lottery ball 21 can pass is provided along the outer peripheral portion of the steering-wheel type rotating device 32, and at least one passage hole having a diameter slightly larger than the diameter of the lottery ball 21 is provided on the outer peripheral surface of the passage.

The lottery ball 21 dropping from the drop hole 30 is stopped at the upper portion of the steering-wheel type rotating device 32, and when the passage hole formed in the steering-wheel type rotating device 32 arrives at the stop position of the lottery ball 21 by rotation of the steering-wheel type rotating device 32, the lottery ball 21 passes through the passage hole and enters the steering-wheel type rotating device 32. The lottery ball 21 entering the steering-wheel type rotating device 32 drops to the lower portion of the steering-wheel type rotating device 32, end when the passage hole is located at the lowermost position of the steering-wheel type rotating device by rotation of the steering-wheel type rotating device 32, the lottery ball 21 further drops from the steering-wheel type rotating device 32.

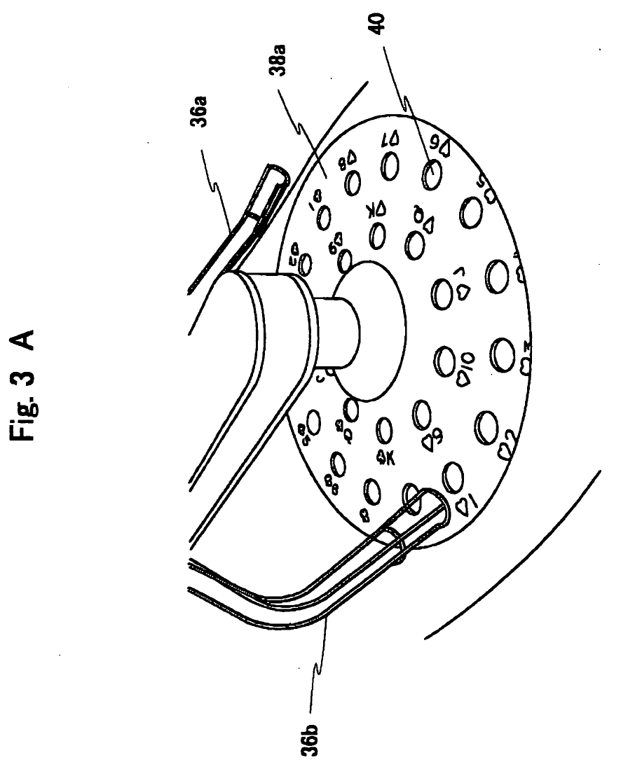

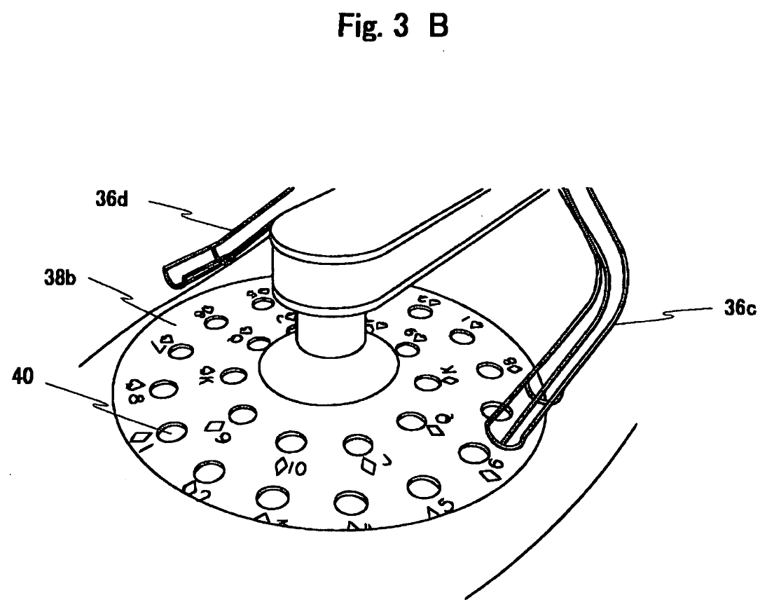

A lottery ball receiving portion 34 is provided at the lower side of the steering-wheel type rotating device 32, and the lottery ball receiving portion 34 is provided with a plurality of slopes 36a to 36d for guiding the lottery ball 21 from the side portion of the lottery ball receiving portion 34 to any one of two lottery boards 38 (38a and 38b) described below. The lottery ball 21 dropping to the lottery ball receiving portion 34 rolls toward any one of the plurality of slopes 36a to 38b, and is guided to the lottery board 38 while rolling on any one of the plurality of slopes 36a to 36d. FIGS. 3A and 3B are enlarged views showing the vicinity of the lottery board 38.

Two lottery boards 38a and 38b are rotatably provided on the deck board of the sailboat type lottery machine 12.

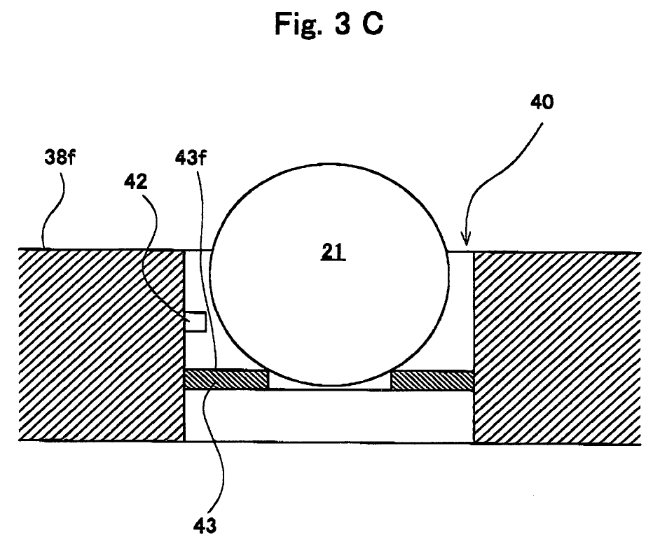

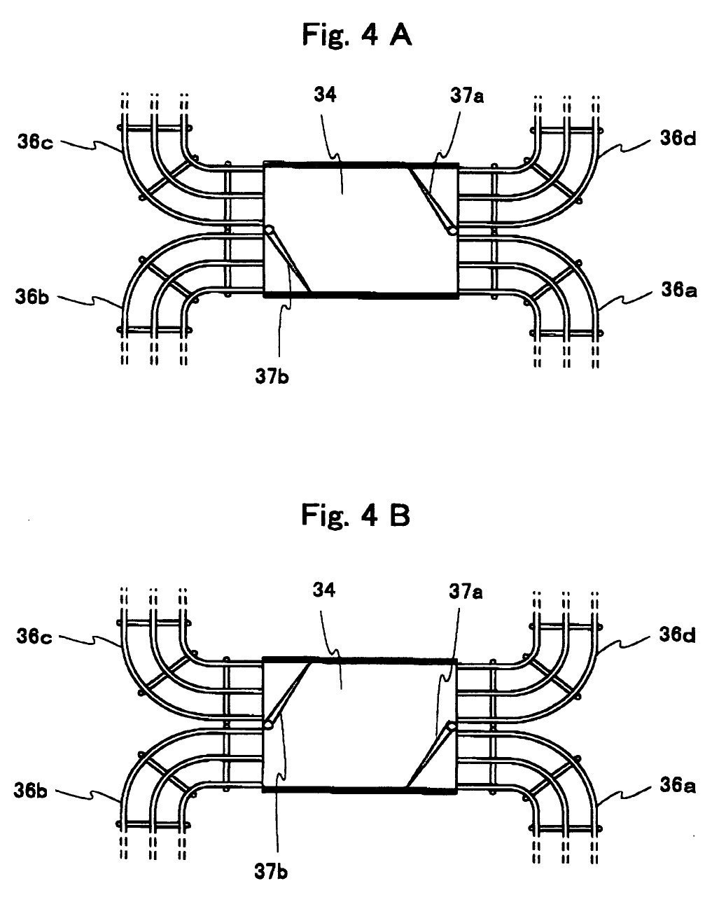

Here, two slopes 36a and 36b are provided to one lottery board 38a. These slopes 36a and 36b are designed so that the slope 36a allows the lottery ball 21 to roll clockwise with respect to the lottery board 38a and the slope 36b allows the lottery ball 21 to roll counterclockwise with respect to the lottery board 38a. Furthermore, two slopes 36c and 36d are provided to the other lottery board 38b. These slopes 36c and 36d are designed so that the slope 36c allows the lottery ball 21 to roll clockwise with respect to the lottery board 38b and the slope 36d allows the lottery ball 21 to roll counterclockwise with respect to the lottery board 38b (see FIGS. 4A and 4B).

Therefore, if the lottery ball 21 rolls while being guided along the slope 36a when the lottery board 38a is clockwise rotated, the traveling direction of the lottery ball 21 is coincident with the rotational direction of the lottery board 38a, and thus the lottery ball 21 can continuously roll without reducing the speed thereof. Therefore, it is difficult for a game player to predict the lottery hole which the lottery ball 21 will enter, and thus the players sense of anticipation can be maintained. However, when the lottery ball 21 rolls while guided along the slope 36b, the traveling direction of the lottery ball 21 and the rotational direction of the lottery board 38a are opposite to each other. At this time, the speed of the lottery ball 21 may be drastically reduced, and thus the lottery ball 21 may immediately enter a lottery hole. At this time, the player cannot maintain his/her sense of anticipation.

Therefore, as shown in FIGS. 4A and 4B, roll preventive valves 37a and 37b are provided to the lottery ball receiving portion 34 so that the lottery ball 21 can be prevented from rolling in the direction opposed to the rotational direction of the lottery board 38. Further, since it may be preferable in some cases that the lottery ball 21 rolls in the direction opposed to the rotational direction of the lottery board 38, the rolling direction may be selected in various manners such as random selection, optional selection, lottery-based selection, etc.

For example, when the two lottery boards 38a and 38b are clockwise rotated, the two roll preventive valves 37a and 37b are located as shown in FIG. 4A, and the passages to the slopes 36a and 36c for the lottery ball 21 to roll out to move clockwise are opened while the passages to the slopes 36b and 36d for the lottery ball 21 to roll out to move counterclockwise are closed.

Conversely, when the two lottery boards 38a and 38b are counterclockwise rotated, the two roll preventive valves 37a and 37b are turned as shown in FIG. 4B so that the passages to the slopes 36a and 38c for the lottery ball 21 to roll out to move clockwise are closed while the passages to the slopes 36b and 36d for the lottery ball 21 to roll out to move counterclockwise are opened.

In another embodiment, the lottery ball 21 rolls in a state that the lottery boards 38a and 38b stay still, and when the lottery ball 21 passes over any one of the slopes 38a to 36d, the rolling out direction of the lottery ball 21 is detected by a sensor provided to the slope to determine the rotational direction of the lottery board 38a or 38b in conformity with the direction. Therefore, the rotational direction of the rotational board 38 and the rolling direction of the lottery ball 21 can be matched with each other.

This embodiment is configured such that the lottery ball 21 rolls out in conformity with the rotational direction of the lottery board 38. However, the present invention is not limited to this embodiment, and the lottery ball may roll in any direction.

Furthermore, in this embodiment, the lottery ball 21 is designed to make a rolling motion on any one of the two lottery boards 38a or 38b. However, the present invention is not limited to this, and the lottery ball 21 may be designed to make a rolling motion so as to trace a figure of eight.

As shown in FIGS. 3A and 3B, each of the lottery boards 38a and 38b are provided with a plurality of lottery holes 40. Each of the lottery holes 40 has a diameter slightly larger than the diameter of the lottery ball 21 (see FIG. 3C) so that the lottery ball 21 can enter the lottery hole. For example, the lottery ball 21 guided by the slope 36 rolls on the rotating lottery board 38a, and enters any one of the lottery holes 40. In this embodiment, each of the lottery boards 38a and 38b is provided with twenty six lottery holes 40.

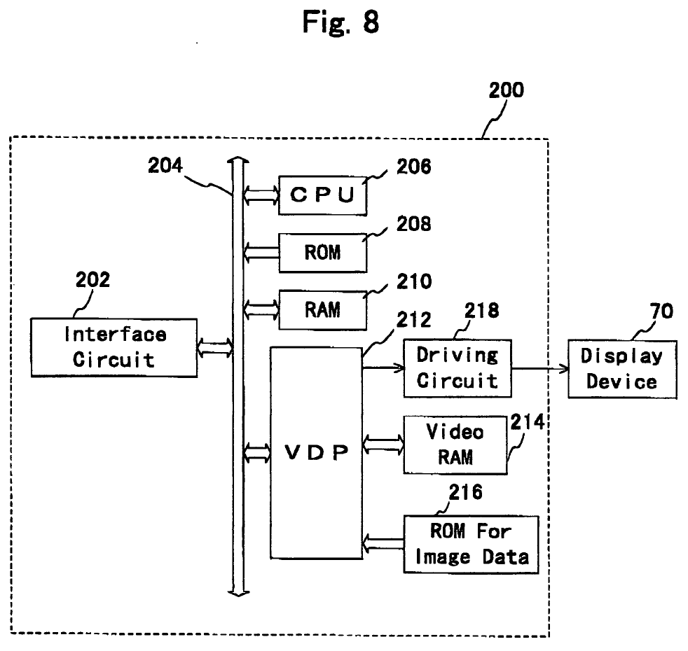

Symbols are allocated to the lottery holes 40, and a ball entrance detecting sensor 42 (see FIGS. 3C and 8) is provided to each of the plurality of lottery holes 40. When the lottery ball 21 enters any one of the lottery holes 40, the ball entrance detecting sensor 42 corresponding to the one of the plurality of lottery holes 40 detects the entrance of the lottery ball, whereby the symbol corresponding to the lottery hole is selected.

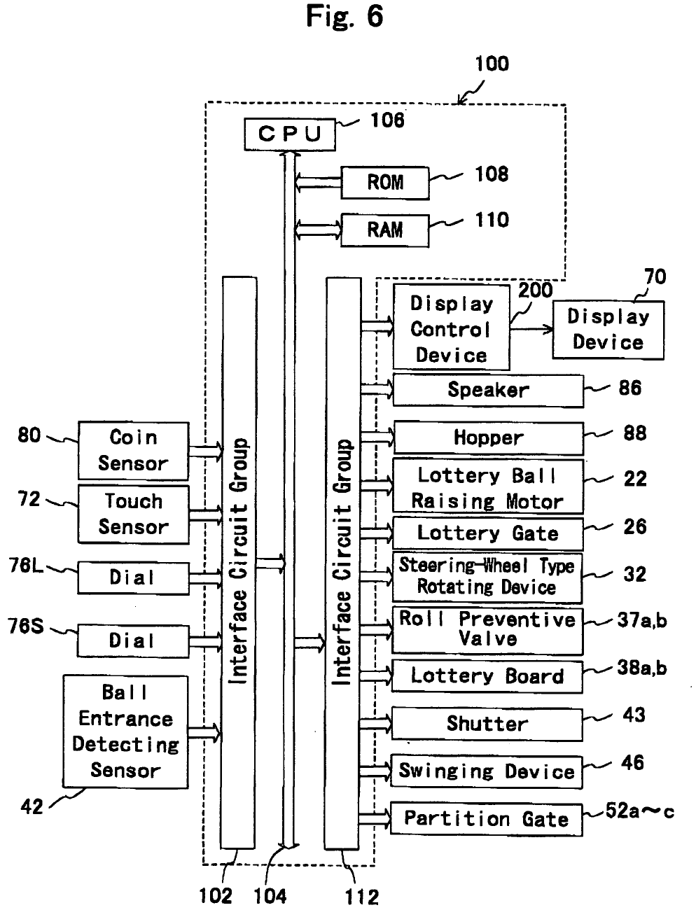

Furthermore, as shown in FIG. 3C, each of the plurality of lot holes 40 is equipped with a shutter 43 (see FIG. 6). Each of these shutters 43 is set to a closed state in advance, and also the surface 43f of each shutter 43 is located to be lower than the surface 38f of the lot board 38a (and 38b) around the surface 43f of the shutter 43. Therefore. when a lot ball 21 enters any lot hole 40, the lot ball 21 is stopped while a part (about ⅖) of the sphere of the lot ball 21 is exposed from the surface 38f of the lot board 38a (and 38b). Accordingly, persons who observe the game condition around the gaming machine 10 can easily recognize which symbol is selected by lot. After all the lotteries are completed, the shutter 43 is driven to be opened, and the lot balls 21 are withdrawn into the sailboat type lot machine 12.

The lottery ball 21 entering any one of the plurality of lottery holes 40 drops into a lottery ball withdrawing passage 44 as shown in FIG. 2, so that it is withdrawn into the sailboat type lottery machine 12.

The sailboat type lottery machine 12 is provided with a swinging device 46, and it is swingable around a swinging shaft 48.

When the lottery ball 21 is withdrawn into the ship, the sailboat type lottery machine 12 is tilted by the driving of the swinging device 46 so that the front portion 12b of the ship body moves upward and the rear portion 12a of the ship moves downward, and the lottery balls 21 in the lottery ball withdrawing passage 44 are fed to the lottery ball standby portion 50 located at the lower side of the rear portion of the ship.

The lottery ball standby portion 50 (50a and 50b) is provided with a plurality of partition gates 52 (52a to 52c) for compartmentalizing the lottery balls 21 every number of lottery balls which are used in one game. In this embodiment, the number of lottery balls 21 to be used in one game is Bet to five, and three partition gates are provided.

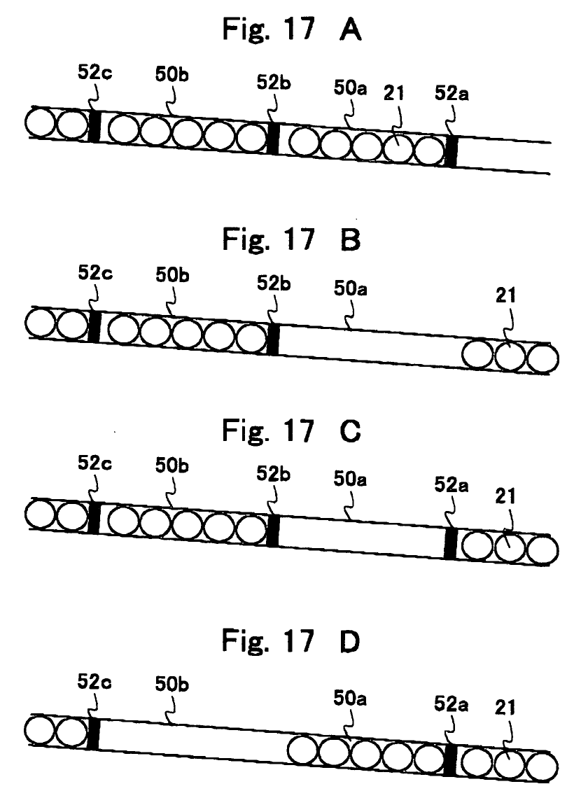

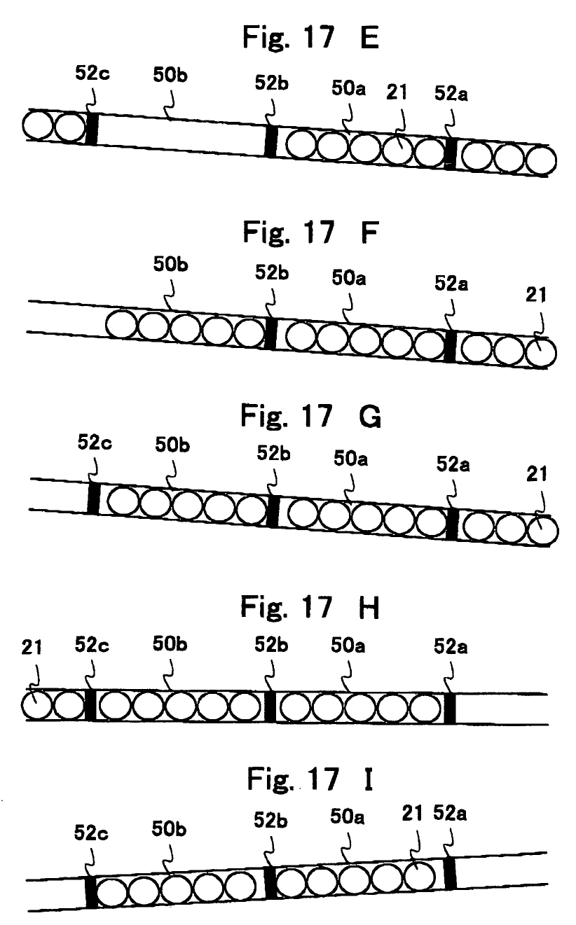

As described above, under the state where the rear portion of the ship is moved downward as shown in FIG. 17A, the partition gate 52a located between the lottery ball standby portion 50 and the lottery ball raising device 20 is first opened, and lottery balls 21 located at the lottery ball standby portion 50a which is located at the side of the lottery ball raising device 20 are fed to the lottery ball raising device 20. After all the lottery balls 21 are fed to the lottery ball raising device 20, the partition gate 52a is closed as shown in FIG. 17C.

Next, the partition gate 52b located between the lottery ball standby portion 50a and the lottery ball standby portion 50b located at the side of the center of the ship is opened as shown in FIG. 17D, and the lottery balls 21 located at the lottery ball standby portion 50b are fed to the lottery standby portion 50a. After all the lottery balls 21 are fed, the partition gate 52b is closed as shown in FIG. 17E.

Furthermore, the partition gate 52c located between the lottery ball standby portion 50b and the lottery ball withdrawing passage 44 is opened as shown in FIG. 17F, and the lottery balls 21 located in the lottery ball withdrawing passage 44 are fed to the lottery ball standby portion 50b. After all the lottery balls 21 are fed, the partition gate 52c is closed as shown in FIG. 17G.

Through the above operation, a required number of lottery balls 21 can be easily moved only by swinging the sailboat type lottery machine 12 and open/close the plurality of partition gates 52a to 52c. When the rear side 12a of the ship and the front side 12b of the ship are in a horizontal position as shown in FIG. 17H or when the ship body is tilted so that the front side 12b of the ship is moved downward and the rear side 12a of the ship is moved upward, a required number of lottery balls 21 can also be easily secured by the partition gates 52a to 52c.

In the above embodiment, the number of sets each of which contains lottery balls 21 used in one game is set to three. However, the present invention is not limited to this, and two sets of lottery balls 21 may be used. In this case, the lottery ball standby portion 50b and the partition gate 52 are unnecessary. Furthermore, four sets, five sets or more sets of lottery balls 21 may be used.

Furthermore, in the above embodiment, the lottery balls 21 in the lottery ball standby portion 50 are partitioned by a plurality of partition gates 52a to 52c every number of lottery balls 21 used in one game, however, the present invention is not limited to this. For example, the above embodiment may be modified so that only one partition gate 52a is provided to the lottery ball standby portion 50, a ball detection sensor is provided in the vicinity of the partition gate 52a, and the partition gate 52a is closed at the point in time when a predetermined number of lottery balls 21 pass through the partition gate 52a, whereby only the predetermined number of a lottery balls 21 can be discharged.

The gaming machine 10 may be provided with a plurality of illumination devices (not shown) to light up the sailboat type lottery machine 12 with various colors, and various representations can be performed in combination with the swing operation.

<Construction of Personal Game Operating Unit>

As shown in FIG. 1, a display device 70 is provided to the upper portion of each personal game operating unit 14. A matrix card for a bingo game which is allocated to each game player, other information or an optical game screen are displayed on the display device 70 so that the game player can visually recognize various kinds of information drawn on the display device and the game advances.

Furthermore, a camera (not shown) for picking up overall images of the lottery boards 38a and 38b is equipped to the sailboat type lottery machine 12 to display the pickup images on the display device 70, so that a game player located at a position where he/she cannot view any one of the lottery boards 38a and 38b is enabled to view the lottery board 38.

Furthermore, the display device 70 is equipped with a touch panel having a touch sensor 72 (see FIG. 6), and the display device 70 is touched by a game player to allow input or instruction of various data.

In this embodiment, various input operations can be carried out by the touch sensor 72. However, the present invention is not limited to the touch sensor, and a plurality of operating buttons may be provided to carry out various input operations.

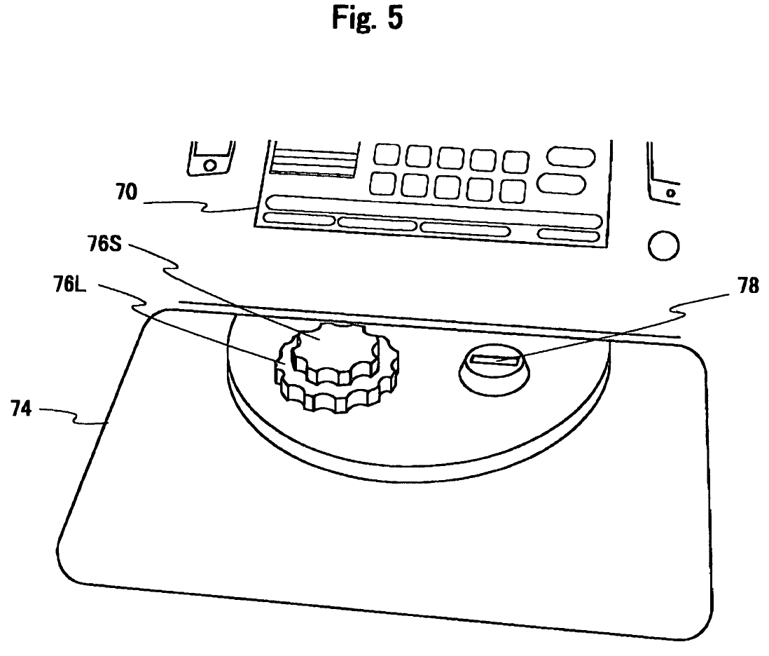

FIG. 5 is an enlarged view showing a part of the personal game operating unit 14.

A substantially horizontal seat portion 74 is provided at the lower side of the display device 70, and two dials 76L and 76S are vertically stacked so as to be slightly shifted from the center to the left side. By using the dials 76L and 76S, a game player can carry out an operation which is difficult to be carried out by merely pressing a normal operating button or touching a touch panel.

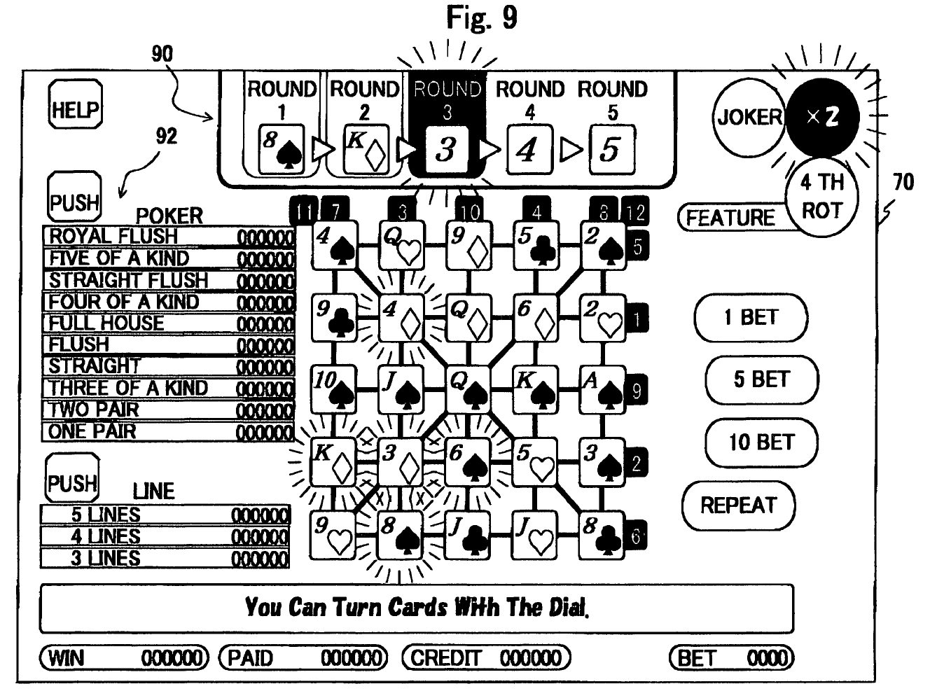

For example, in this embodiment, in a matrix card (see FIG. 9) for a bingo game displayed on the display device 70, it is possible that respective symbols drawn on the cells adjacent to the outer periphery of the matrix are shifted to the adjacent cells one by one. When the sequential shift as described above is carried out by button operation, touch panel operation or the like, the operation must be repeated many times, However, by using an input device such as the dials 76L and 76S as described above, the sequential operation can be performed by only one motion. Therefore, the game player can easily carry out the operation.

Furthermore, the game player can very simply carry out the operation for analog motions such as a scrolling motion on a screen, movement of a pointer, etc.

A coin slot 78 for dropping a coin into the gaming machine 10 is provided at the right side of the dials 76S and 76S. When the game player drops a coin into the coin slot 78, a coin sensor 80 (see FIG. 6) provided in the personal game operating unit 14 detects drop-in of a coin, so that the game can be started.

A coin payout port 82 (see FIG. 1) is provided at the lower side of the seat portion 74. When a payout operation is carried out on the touch panel by the game player, the drop-in coin is paid out from the coin payout port 82.

[Construction of Controller of Gaming Machine]

FIG. 6 is a block diagram showing a circuit construction containing a main control circuit for controlling the gaming machine 10 and a peripheral device electrically connected to the main control circuit.

The coin sensor 80 is connected to an interface circuit group 102 of the main control circuit 100, and a detection signal thereof is converted to a predetermined signal by the interface circuit group 102 and then supplied to an input/output bus 104. The input/output bus 104 is designed so that a data signal or address signal is input to a central processing circuit (hereinafter referred to as CPU).

A touch sensor 72 is also connected to the interface circuit group 102 of the main control circuit 100. When the touch sensor 72 detects that a display position of a display content displayed on the display device 70 is touched by a game player, the touch sensor 72 supplies the signal corresponding to the indication content to the interface circuit group 102.

Furthermore, the dials 76L and 76S are connected to the interface circuit group 102. When the dial 76L or 76S is rotated by the game player, a signal corresponding to each rotational angle is supplied to the interface circuit group 102.

The ball entrance detecting sensors 42 are also connected to the interface circuit group 102 described above. When the ball entrance detecting sensor 42 detects that a lottery ball 21 enters the corresponding lottery hole 40, the ball entrance detecting sensor 42 supplies the corresponding signal to the interface circuit group 102.

ROM (read only memory) 108 and RAM (random access memory) 110 are connected to the input/output bus 104 described above. In ROM 108 is stored a control program for controlling the flow of the overall game in the gaming machine 10. Furthermore, in ROM 108 are stored initial data for executing the control program, a program for controlling the display operation of the display device 70, etc. RAM 110 stores flags and values of variables used in the above program.

Furthermore, the input/output bus 104 is connected to the interface circuit group 112. A speaker 86 and a hopper 88 are connected to the interface circuit group 112, and the interface circuit group 112 supplies driving signals and driving power to control the various devices described above on the basis of a processing result of CPU 106.

To the interface circuit group 112 are further connected the lottery ball raising motor 22, the lottery gate 26, the steering-wheel type rotating device 32, the roll preventive valves 37a and 37b, the lottery boards 38a and 38b, the shutter 43, the swinging device 46 and the partition gates 62a to 52c. This connection arrangement enables the driving operation of the sailboat type lottery machine 12 as described above.

Furthermore, a display control device 200 is connected to the interface circuit group 112, and generates a driving signal to drive the display device 70 connected thereto on the basis of an image display command output from the main control circuit 100.

[Internal Lottery Method]

In the processing of each game operating unit described later, an internal lottery is carried out to prepare a matrix card. Through the internal lottery, random numbers are generated and internal lottery data are acquired on the basis of the random numbers.

With respect to the method of generating the random numbers in the internal lottery, any one of an external random number system and a software random number system is used. According to the external random number system, random numbers are generated by an unit for generating random numbers such as a binary counter IC or the like which is provided on a substrate separately from CPU. According to the software random number system, the CPU itself creates a counter, renews the numerical value of the counter according to a program stored in ROM and uses the numerical value as a random number.

In the gaming machine 10 of this embodiment, random numbers are generated by using the software random number system. The random number generating method of the gaming machine 10 according to the present invention is not limited to the software random number system, and the external random number system, a system for extracting a numerical value from a plurality of numerical values without making the game player feel regularity or the like may be used.

A random number acquired by the lottery described above is converted to a symbol code by using a conversion table stored in ROM 108, and then the symbol code is recorded.

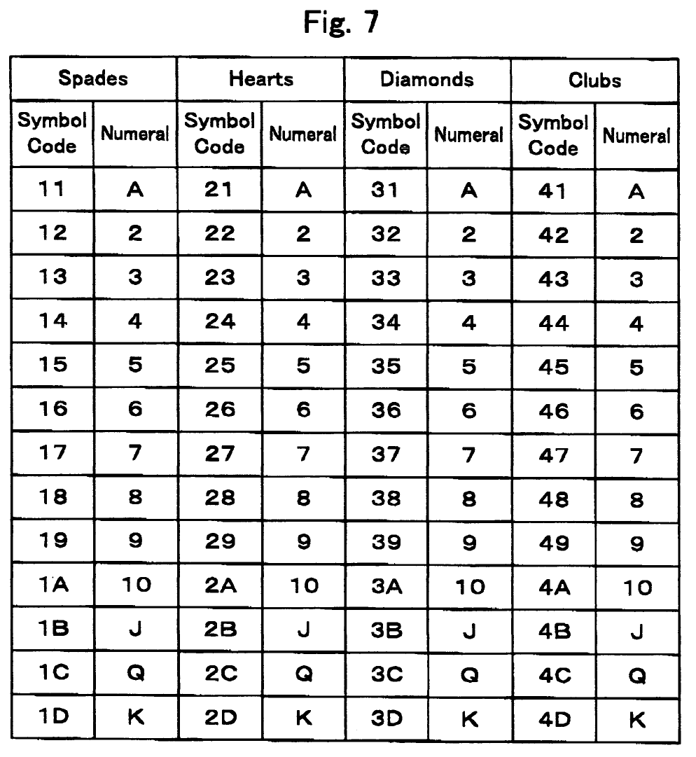

The symbol code is a code for identifying each of the cards of a card game (trump) which correspond to symbols used in the game of the present invention, and these symbol codes are classified as shown in FIG. 7, for example. CPU 106 identifies a mark of each symbol on the basis of an upper digit of the symbol code, and also identifies a numeral of the symbol on the basis of a lower digit of the symbol code, thereby determining whether a combination of symbols on each line forms a winning combination.

[Construction of Display Control Device of Gaming Machine]

FIG. 8 is a block diagram showing the circuit of the display control device 200 described above.

An interface circuit 202 is connected to an input/output terminal 204, and an image display command output from the main control circuit 100 described above is supplied to the input/output bus 204 through the interface circuit 202. The input/output bus 204 is designed so that a data signal or address signal is input to CPU 206.

ROM 208 and RAM 210 are also connected to the input/output bus 204 described above, ROM 208 stores a display control program for generating a driving signal to be supplied to the display device 70 on the basis of an image display command output from the main control circuit 100. In RAM 210 are stored flags and values of variables used in the program.

Furthermore, an image data processor (hereinafter referred to as VDP) 212 is also connected to the input/output bus 204. VDP 212 is a processing device which includes circuits such as a so-called sprite circuit, a screen circuit, a palette circuit, etc., and can carry out various kinds of processing for displaying images on the display device 70.

To VDP 212 described above are connected video RAM 214 for storing image data corresponding to an image display command output from the main control circuit 100, image data of background, and image data ROM 216 for storing image data such as image data of figures, etc.

CPU 206 reads out and executes the display control program stored in ROM 208, and stores into RAM 214 image data to be displayed on the display device 70 in response to the image display command output from the main control circuit 100. The image display command output from the main control circuit 100 contains display commands such as a background display command a figure display command, a character display command, etc.

The image data ROM 216 stores image data such as image data of figures corresponding to identification information images, character image data of characters such as moving bodies, etc., displayed as representation display frames, background image data constituting backgrounds for the display device 70, etc.

After respective image data described above are synthesized in VDP 212, the image data thus synthesized are transmitted to the driving circuit 218, and the driving circuit 218 drives the display device 70 to display images on the display device 70.

[Display Example of Image]

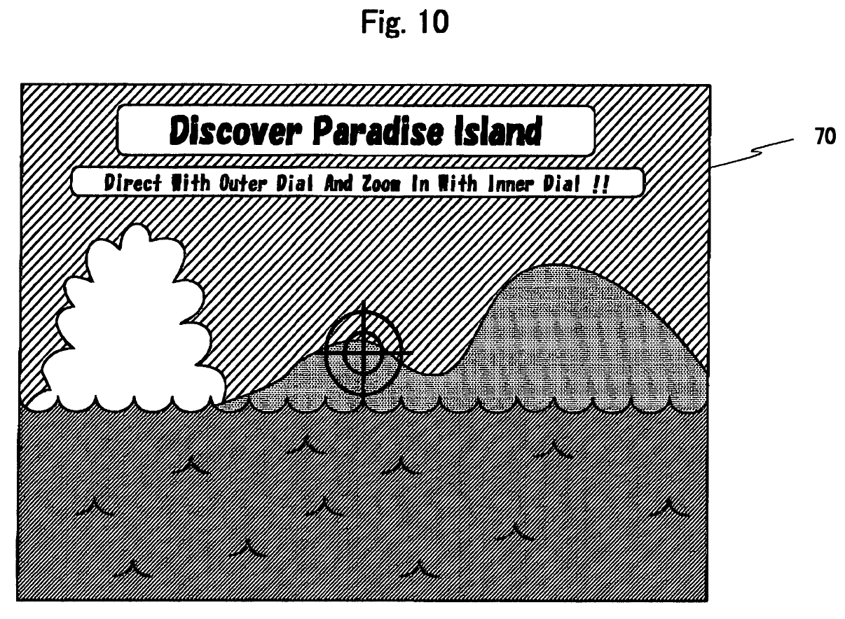

By recording the image data on the video RAM 214 as described above, the images are displayed on the display device 70, and the game advances. Display examples of images displayed in the game are shown in FIGS. 9 and 10.

FIG. 9 shows a display example when a matrix card in a bingo game is displayed on the display device 70. In the bingo game of this embodiment, numerals are not displayed, but figures of cards are displayed as symbols on the respective cells.

A symbol selected by a lottery is displayed at the center of the upper side 90 of the display device 70. In the case of FIG. 9, “eight of spades” is selected by a first lottery and “the king of diamonds” is selected by a second lottery.

Furthermore, winning combinations of a poker game and payouts associated with the winning combinations are displayed at the left side 92 of the screen of the display device 70. In the bingo game of this embodiment, not only a payout is paid to a game player because a line of cards is completed as a result of lottery, but also a payout to be paid is increased according to a winning combination of the poker game when a combination of symbols on the completed line completes the winning combination of the poker game. Therefore, a game player alms to both complete a line of cards and complete a winning combination of cards. Therefore, the game player aims to achieve a higher payout by moving cells in a trial-and-error style while manipulating the dials 76L and 76S.

Furthermore, various display frames such as an optional game, etc., as well as the bingo game can be displayed on the display device 70.

FIG. 10 shows a display example when a treasure hunt game is displayed as an optional game.

In this game, a game player scrolls the screen in the right-and-left direction by rotating the dial 76L, and also zooms in the screen by rotating the dial 76S. If the game player finds a treasure within the time and matches the treasure with the cursor located at the center of the screen, he/she can obtain a payout.

Analog input operations such as scroll, zoom-in, etc., are more appropriate for the game as described above than input operations such as a button pressing operation, etc., and thus such a game can be simply carried out by using an input device such as the dials 76L and 76S. This game may be carried out without using any lottery ball, and thus it may be set as a standby screen when other game players execute a game using a lottery ball.

[Operation of Gaming Machine]

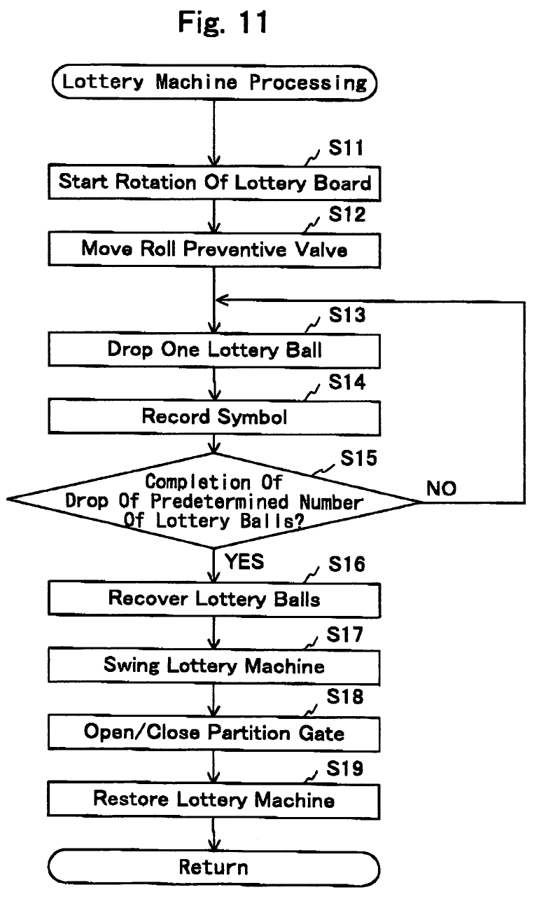

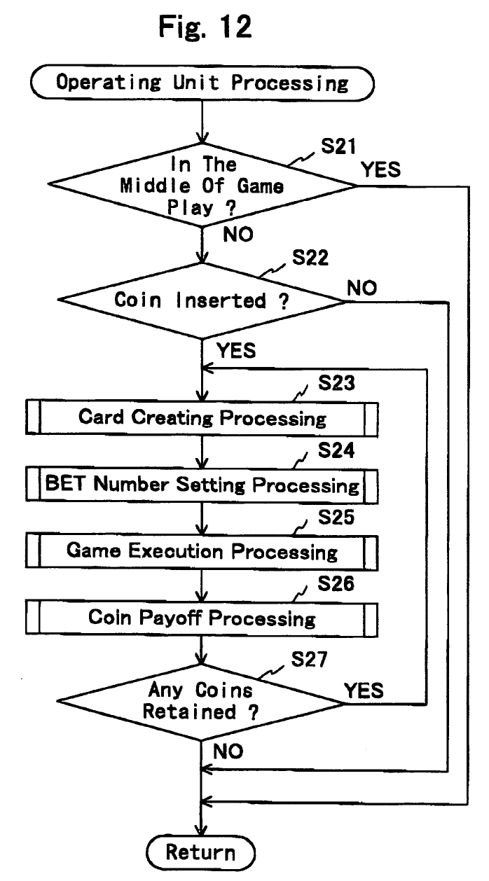

FIGS. 11 to 16 show subroutines for controlling the gaming machine 10 which are executed in the main control circuit 100. Subroutines shown in FIGS. 11 and 12 are called at a predetermined timing from the main program of the gaming machine 10 being executed in advance to be executed.

In the following description, it is assumed that the gaming machine 10 is started in advance, variables used in CPU 106 described above are initialized and the gaming machine is stationarily operated.

[Processing of Lottery Machine]

FIG. 11 shows a subroutine for controlling the processing executed in the sailboat type lottery machine 12.

First, rotation of the lottery boards is started in the processing of step S11. In this processing, CPU 106 starts rotation of the two lottery boards 38a and 38b. After this processing is completed, the processing proceeds to step S12.

Subsequently, in the processing of step S12, the roll preventive valves are moved. In this processing, CPU 106 permits use of only slopes out of the four slopes 36a to 36d, along which the lottery ball 21 can be guided in conformity with the rotational directions of the lottery boards 38a and 38b. Therefore, the two roll preventive valves 37a and 37b are turned to close the routes to the slopes which should be made unavailable. Accordingly, the lottery ball 21 is allowed to roll in the direction matched with the rotational directions of the lottery boards 38. After this processing is completed, the processing proceeds to stop S13.

Subsequently, In the processing of step S13, one of the lottery balls 21 raised by the lottery ball raising device 20 is made to drop. In this processing, CPU 106 opens the lottery gate 28 to pass only one lottery ball 21 through the lottery gate 26. The lottery gate 26 is closed again at the point in time when one lottery ball 21 passes through the lottery gate 26. As described above, the lottery ball 21 thus having passed passes through the upper gutter 28, drops down from the drop hole 30 to the steering-wheel type rotating device 32 and further the lottery ball receiving portion 34. Further, the lottery ball 21 passes through any one of the slopes 36a to 36d, and then rolls to anyone of the lottery boards 38a and 38b. After the above processing is completed, the processing proceeds to step S14.

Subsequently, a lottery result is recorded in the processing of step S14. In this processing, CPU 106 records a symbol selected by the lottery. CPU 106 receives a signal indicating entrance of the lottery ball 21 from the ball entrance detecting sensor 42 corresponding to any one of the lottery holes 40 which the lottery ball 21 enters, records the symbol corresponding to the signal as a lottery result, and also displays the symbol on each display device 70. After the above processing is completed, the processing proceeds to stop S15.

Subsequently, in the processing of step S15, it is determined whether drop of a predetermined number of lottery balls 21 is finished. In this processing, CPU 106 determines whether the drop of the predetermined number of lottery balls 21 is finished. When it is determined that the predetermined number of lottery balls 21 has not yet been finished, CPU 106 returns the processing to step S13. If it is determined that the predetermined number of lottery balls 21 has already dropped, CPU 106 returns the processing to step S16. Since it takes some time from the passage of the lottery ball 21 through the lottery gate 26 until entrance of the lottery ball to any lottery hole 40, a more accurate determination may be made by using various methods, for example, by making determination after a predetermined period of time elapses from the passage of the lottery ball 21 through the lottery gate 26.

Subsequently, in the processing of step S16, the lottery balls 21 are withdrawn. In this processing, CPU 106 opens the shutter 43 provided to the lottery hole 40 which the lottery ball 21 has entered, withdraws the lottery balls 21 and then closes the shutter 43 again. Accordingly, the lottery balls entering the lottery holes 40 during game are allowed to be partially continuously exposed from the lottery holes 40 until the game ends. Therefore, a person who can hardly watch the display device 70 can easily recognize which symbol is selected. After the above processing is completed, the processing proceeds to step S17.

Subsequently, in the processing of step S17, the sailboat type lottery machine 12 is swung. In this processing, CPU 106 drives the swinging device 46 as shown in FIGS. 17A to 17G to swing the sailboat type lottery machine 12. After the above processing is completed, the processing proceeds to step S18.

Subsequently, in the processing of step S18, the partition gate 52 is opened/closed. In this processing, CPU 106 successively opens/closes the partition gates 52a, 52b and 52c. Accordingly, the lottery balls 21 located at the lottery ball standby portion 50a are fed to the lottery ball raising device 20, the lottery balls 21 located at the lottery ball standby portion 50b are fed to the lottery ball standby portion 50a, and the lottery balls 21 located at the lottery ball withdrawing passage 44 are fed to the lottery ball standby portion 50b. Accordingly, as described above, conveyance of lottery balls 21 used in the next game and movement of withdrawn lottery balls 21 to the lottery ball standby portion 50 can be simultaneously performed. After the above processing is completed, the processing proceeds to step S19.

In the above embodiment, the lottery balls 21 in the lottery ball standby portion 50 are partitioned by the partition gates 52 every number of lottery balls 21 used in one game. However, the present invention is not limited to this. For example, this embodiment may be modified so that only one partition gate 52a is provided to the lottery ball standby portion 50, a ball detecting sensor is provided in the vicinity of the partition gate 52a, and the partition gate 52a is closed at the point in time when a predetermined number of lottery balls 21 pass through the partition gate 52a, whereby only the predetermined number of lottery balls 21 can be discharged.

Subsequently, in the processing of step S19, the sailboat type lottery machine 12 is returned to the original position. In this processing, CPU 106 drives the swinging device 46 to return the sailboat type lottery machine 12 to the original position. After the above processing is completed, this subroutine immediately ends.

In another embodiment, the lottery ball 21 is rolled under the state where the lottery boards 38a and 38b stay still, and the rolling direction of the lottery ball 21 is detected by a sensor provided to any one of the plurality of slopes 36a to 36d when the lottery bell 21 passes through any one of the plurality of slopes 36a to 36d. The rotational direction of the lottery board 38a or 38b is determined in conformity with the rolling direction, whereby the rotational direction of the lottery board 38a or 38b and the rolling direction of the lottery ball 21 can be matched with each other. In this case, the processing of step S11 is carried out after the processing of step S13, and the processing of step S12 is not carried out.

[Processing of Operating Unit]

FIG. 12 shows a subroutine for controlling the advance of the game in the personal game operating unit 14.

In the processing of step S21, it is first determined whether the gaming machine 10 is in the game play. In this processing, CPU 106 determines whether the gaming machine 10 is in the game play. If CPU 106 determines that the gaming machine 10 is in the game play, CPU 106 immediately finishes this subroutine without carrying out any processing because a game player cannot participate in the game. If CPU 106 determines that the gaming machine 10 is not in the game play, CPU 106 shifts the processing to step S22.

Subsequently, in the processing of step S22, it is determined whether a coin is thrown into the gaming machine. In this processing, CPU 106 determines that a signal indicating detection of throw-in of a coin is received from the coin sensor 80. If it is determined that the signal is not received, that is, if it is determined that no coin is inserted by a game player, CPU 106 immediately finishes this subroutine without carrying out any processing. If it is determined that the signal is received, that is, if it is determined that a coin is thrown in by a game player, CPU 106 shifts the processing to step S23.

Subsequently, in the processing of step S23, matrix cards are created. In this processing, CPU 106 creates a predetermined number of matrix cards on which figures of trump cards are arranged by lottery. This processing will be described later. After the above processing is completed, CPU 106 shifts the processing to step S24.

Subsequently, in the processing of step S24, the number of bets is set. In this processing, CPU 106 promotes a game player to input a desired number of bets, and the number of bets in the game is set on the basis of information input by the game player. This processing will be described later. After this processing is completed, CPU 106 shifts the processing to step S25.

Subsequently, the game is executed in the processing of step S25. In this processing, CPU 106 selects figures of trump cards one by one by lottery, and the game advances according to this lottery. The lottery is repeated at a predetermined number, and the game is finished at the point of time when the predetermined number of lotteries are finished. This processing will be described later. After the above processing is completed, CPU 106 shifts the processing to step S26.

Subsequently, Payoff of coins is carried out in the processing of step S26. In this processing, CPU 106 carries out the Payoff of coins on the basis of the result of the game executed in step S25. This processing will be described later. After the processing of step S27 is completed, CPU 106 shifts the processing to step S27.

Subsequently, in the processing of step S27, it is determined whether there are some remaining coins. In this processing, CPU 106 determines whether some coins which are thrown in by the game player or acquired by the game player still remain in the gaming machine 10. If it is determined that some coins having been thrown in or acquired by the game player still remain in the gaming machine 10, the game can be carried out newly, and thus CPU 106 returns to the processing of step S23. If it is determined that no coin having been thrown in or acquired by the game player remains in the gaming machine 10, CPU 106 immediately finishes this subroutine because the game cannot be further continued.

[Card Creating Processing]

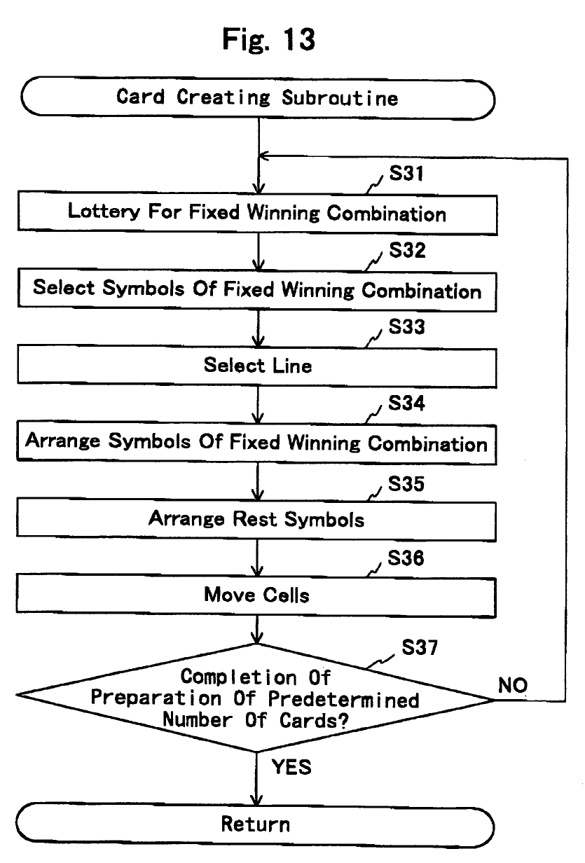

In the step S23 described above, a subroutine as shown in FIG. 13 is called. In this case, a card as shown in FIG. 9 is created as an example.

First, in the processing of step S31, a winning combination is selected by lottery on the assumption that only one winning combination is necessarily established in a matrix card. In this processing, CPU 106 determines one winning combination from a list of fixed winning combinations stored at a predetermined position of ROM 108. After this processing is completed, CPU 106 shifts the processing to step S32.

Subsequently, in the processing of step S32, symbols used in the fixed winning combination are selected. In this processing, CPU 106 selects the symbols used in the fixed winning combination in the above step S31. CPU 106 treats a matrix card comprising 5 cells×5 cells in the rows and the columns respectively as shown in FIG. 9, and thus five symbols needed to form the winning combination are selected.

For example, in the case of a poker game, if the fixed winning combination is a “royal straight flush,” one of four marks of spades, hearts, diamonds and clubs selection made by lottery. In the case of the winning combination, the numerals are necessarily limited to fives of A, K, Q, J, 10, and thus only the mark may be selected by lottery.

Furthermore, if the fixed winning combination is a “full house,” one symbol is first selected, and then two symbols which are identical to the symbol in numeral, but different from the symbol in mark are selected. Subsequently, one symbol comprising a numeral different from the above numeral is selected, and one symbol which is identical to the above symbol in numeral, but different from the above symbol in mark is selected. Accordingly, a combination of a set of symbols comprising the same numeral and a set of two symbols comprising the same numeral which is different from the former numeral is completed.

After the above processing is completed, CPU 106 shifts the processing to step S33.

Subsequently, in the processing of step S33, a line on which the fixed winning combination is arranged is selected. In this processing, CPU 106 determines the position of the line on which the winning combination of the symbols determined in the step S32 is described above. CPU 106 selects, by lottery, one of twelve rows on the matrix card (corresponding to inversely-displayed numerals from 1 to 12 in FIG. 9) on which the symbols constituting the fixed winning combination should be arranged, and determines one line. After this processing is completed, CPU 106 shifts the processing to step S34.

Subsequently, in the processing of step S34, the symbols constituting the fixed winning combination are arranged. In this processing, CPU 106 arranges the five symbols determined in step S32 on the line determined in step S33. CPU 106 determines the positions of five cells on the line at which the five symbols should be respectively disposed, and arranges all the symbols on the line. After the above processing is completed, CPU 106 shifts the processing to step S35.

Subsequently, in the processing of step S35, the arrangement of symbols on the other cells is carried out. In this processing, CPU 106 arranges symbols on the other twenty cells on which the symbols are not arranged in the above step S34. CPU 106 determines each symbol to be arranged on each of the twenty cells by lottery, and arranges the symbol selected by lottery on the cell, whereby the symbols are arranged on all the twenty five cells on the matrix card. After the above processing is completed, CPU 106 shifts the processing to step S36.

Subsequently, in the processing of step S36, the cell movement can be carried out. In this processing, CPU 106 may move each of the outer peripheral cells and inner peripheral cells so that the symbols constituting the fixed winning combination which are arranged from the step S31 to the step S34 are not arranged on one line. After this processing is carried out or after it is selected that this processing is not executed, CPU 106 shifts the processing to step S37.

Subsequently, in the processing of step S37, it is determined whether preparation of a predetermined number of matrix cards is completed. In this processing, CPU 106 determines whether the number of matrix cards created in the processing from the step S31 to the step S35 reaches the predetermined number. If it is determined that the preparation of the predetermined number of matrix cards has not yet been completed, CPU 106 returns to the processing of step S31 to create the remaining cards. If it is determined that the preparation of the predetermined number of cards has been completed, CPU 106 immediately finishes this subroutine.

In this embodiment, the symbols are arranged so that a winning combination which may be established according to a way of moving the cells is contained in a matrix card. However, the present invention is not limited to this, and symbols may be arranged on all the cells by lottery. In this case, only the step S35 described above is carried out, and the processing of the other steps S31 to S34 and the step S36 does not need to be executed.

[Processing of Setting Number of Bets]

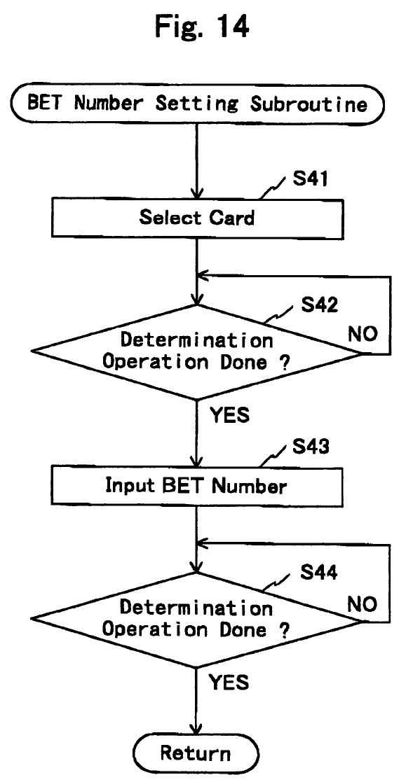

In the step 24 described above, a subroutine shown in FIG. 14 is called.

In the processing of step S41, a card selection screen is displayed. In this processing, CPU 106 displays a card selection screen on the display device 70, and promotes a game player to select one of the plurality of cards created in the step S23 of FIG. 12. At this time, one of the plurality of cards is displayed on the display device 70. With respect to the other remaining cards, the game player carries out a selecting operation to exchange the displayed one card with one of the other cards and displays the one card thus exchanged. By repeating this operation, all the cards created in step S23 of FIG. 12 can be displayed for the game player. After this processing is completed, CPU 106 shifts the processing to step S42.

Subsequently, in the processing of step S42, it is determined whether a settling operation is carried out. In this processing, CPU 106 determines whether the game player carries out the settling (enter) operation. When CPU 106 does not receive from the touch sensor 72 a signal indicating that the operation has been carried out, CPU 106 determines that the settling operation has not yet been carried out by the game player, and repeats this step. On the other hand, when CPU 106 receives from the touch sensor 72 a signal indicating that the above operation is carried out, CPU 106 determines that the settling operation is carried out by the game player, and shifts the processing to step S43.

Subsequently, in the processing of step S43, an input screen of the number of bets is displayed. In this processing, CPU 106 displays on the display device 70 a screen for promoting the game player to determine the number of coins to be bet to the selected card. At this time, a table indicating odds to the bet number of coins in connection with the types of completed winning combinations is displayed on the screen in addition to the card. The game player determines the number of coins to be bet by referring to this table. After this processing is completed, CPU 106 shifts the processing to step S44.

Subsequently, in the processing of step S44, it is determined whether the settling operation is carried out. In this processing, CPU 106 determines whether the settling operation is carried out after inputting the betting number of coins desired by the game player. When not receiving from the touch sensor 72 a signal indicating that the operation is carried out, CPU 106 determines that the settling operation has not yet been carried out by the game player, and repeats this subroutine, if receiving from the touch sensor 72 a signal indicating that the operation has been carried out, CPU 106 determines that the settling operation is carried out by the game player, and finishes this subroutine immediately.

[Game Execution Processing]

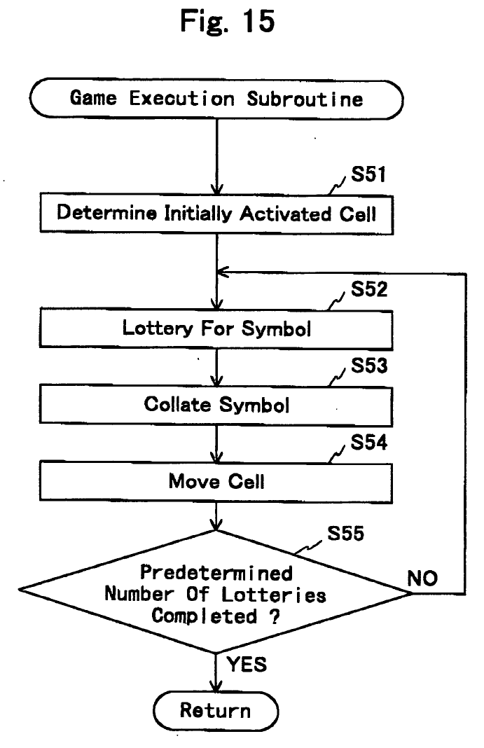

In the step S25 described above, a subroutine shown in FIG. 15 is called.

In the processing of step S51, an initially effective call is determined. In this processing, CPU 106 selects an initially effective cell from the twenty-five cells on a matrix card by lottery. The initially effective cell is a cell which has been effective from the start time of a game. CPU 106 draws lotteries regarding the number of the initially effective cells and the positions thereof, and activates the effective cells on the basis of the lottery result. After the above processing is completed, CPU 106 shifts the processing to step S52.

In this embodiment, the number of initially effective cells is determined by lottery. However, the present invention is not limited to this number and a fixed number of initially effective cells may be set in advance.

Subsequently, lottery of symbols is carried out in the processing of step S52. In this processing, by driving the sailboat type lottery machine 12, CPU 106 selects one symbol by lottery. CPU 106 receives from any one of the ball entrance detecting sensor 42 a signal associated with the symbol corresponding to any one of a plurality of holes 40 which the lottery ball enters, and displays the symbol thus selected in a list of lottery results displayed at the upper portion 90 of the display device 70. After the above processing is completed, CPU 106 shifts the processing to step S53.

Subsequently, a symbol collation is carried out in the processing of step S53. In this processing, CPU 106 collates the symbol selected in the above step S52 with the symbols displayed on the matrix card displayed on the display device 70. If the same symbol as the selected symbol is displayed on the matrix card, the cell on which the symbol is displayed is activated, and the color of the cell is changed. After the above processing is completed, CPU 106 shifts the processing to step S54.

Subsequently, in the processing of step S54, cell moving processing of moving cells can be carried out. In the processing, CPU 106 enables cells to be moved by the dials 76L and 76S, and allows a game player to move the cells by manipulating the dials 76L and 76S. When the dial 76L is rotated by a game player, symbols allocated to the respective cells adjacent to the outer peripheral portion of a matrix card displayed on the display device 70 are moved to adjacent cells thereto one by one according to the rotational angle of the dial 76L. This cell moving processing may be allowed to be carried out at all times, however, it may be allowed to be carried out under a predetermined condition. For example, the cell moving processing may be made impossible after a predetermined number of lotteries are completed. After the above processing is completed or after it is selected not to execute the cell moving processing as described above, CPU 106 shifts the processing to step S55.

Subsequently, in the processing of step S55, it is determined whether a predetermined number of lotteries are carried out. In this processing, CPU 106 determines whether the lottery of a symbol in the step S52 is carried out for a predetermined number of times. If it is determined that the number of lotteries having been executed has not yet reached the predetermined number, CPU 106 returns to the processing of step S52. If it is determined that the number of lotteries having been executed has reached the predetermined number, CPU 106 immediately finishes this subroutine. For example, in the case of a game combined with a poker game, it is preferable that this symbol lottery is carried out at five or more times.

[Coin Payoff Processing]

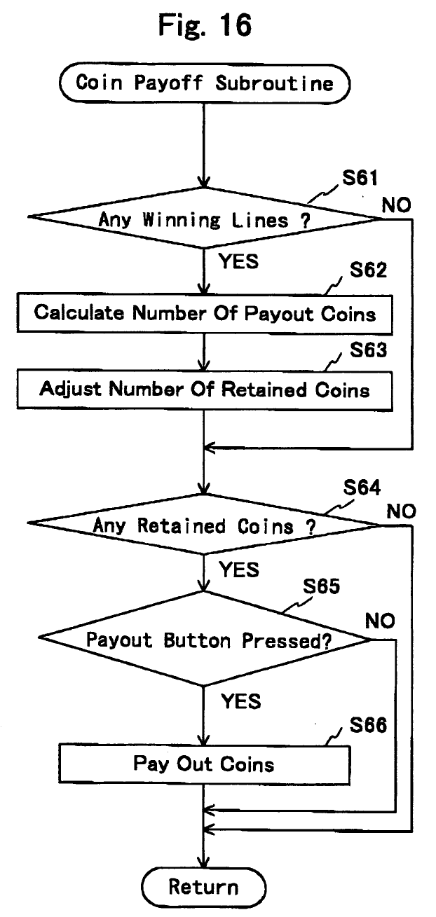

In the above step S26, a coin payoff subroutine as shown in FIG. 16 is called.

First, in the processing of step S61, it is determined that a winning line exists on the plurality of rows on the matrix card. In this processing, CPU 106 determines whether a line having a predetermined number of activated cells exists in the plurality of rows having combinations of symbols on the matrix card displayed on the display device 70. When CPU 106 determines that no winning line exists in the plurality of rows, CPU 106 shifts the processing to step S64. If any line exists in the plurality of rows, CPU 106 shifts the processing to step S62.

Subsequently, in the processing of step S62, the number of coins to be paid out is calculated.

In this processing, the number of coins bet on the game played by the game player is multiplied by the payout odds corresponding to the type of winning combination of the line determined as a winning line in step S61, whereby CPU 106 calculates the payout number of coins. At this time, when a plurality of winning rows exist, the odds of the winning combinations having the highest payout odds out of the plurality of winning combinations are applied. After the above processing is completed, CPU 106 shifts the processing to step S63.

In this embodiment, when a plurality of winning rows exist, the odds of the winning combination having the highest payout odds out of the plurality of winning combinations are applied. However, the present invention is not limited to this. For example, it may be modified so that the payout odds of all the winning combinations may be added to one another, and the number of coins bet by the game player is multiplied by the payout odds thus calculated.

Subsequently, in the processing of step S63, CPU 106 adds the number of payout coins calculated in step S62 to the number of coins which are thrown in the gaming machine 10 by the game player, but remain because they are not bet on the game. After this processing is completed, CPU 106 shifts the processing to step S64.

Subsequently, in the processing of step S64, it is determined whether some coins remain. In this processing, CPU 106 determines whether there remain any coins which were thrown in the gaming machine by the game player or paid out because of winning of the game and stocked in the gaming machine 10. If it is determined that no remaining coin exists, CPU 106 immediately finishes this subroutine without carrying out any processing because the game cannot be further carried out. If it is determined that any coins remain, CPU 106 shifts the processing to step S65.

Subsequently, in the processing of step S65, it is determined that a payout operation is carried out. In this processing, CPU 106 determines whether the payout operation is carried out by the game player. When not receiving a signal from the touch sensor 72 indicating that the operation is carried, CPU 106 determines that no payout operation has been carried out by the game player, and immediately finishes this subroutine without carrying out any processing. When not receiving a signal from the touch sensor 72 indicating that the operation has been carried out, CPU 106 determines that the payout operation has been carried out by the game player, and shifts the processing to step S66.

Subsequently, in the processing of step S66, the payout processing of coins is carried out. In this processing, CPU 106 transmits to a hopper 88 a signal indicating payout of the total number of coins acquired by adding the number of coins gained through the game by the game player with the number of coins which are stocked in the gaming machine 10 because these coins are thrown in the gaming machine 10 by the game player, but are not bet on the game. The hopper 88 receiving the signal discharges the total number of coins from a coin payout port 82. After the above processing is completed, CPU 106 immediately finishes this subroutine.

Next, a second embodiment according to the present invention will be described hereunder.

A gaming machine 310 according to this embodiment is a gaming machine with which a game is played by using not only coins, medals, game balls or tokens, but also game media such as cards or the like which are given to game players or in which game valuable information to be given to game players is stored, The following description will be made on the assumption that medals are used.

[Construction of Gaming Machine]

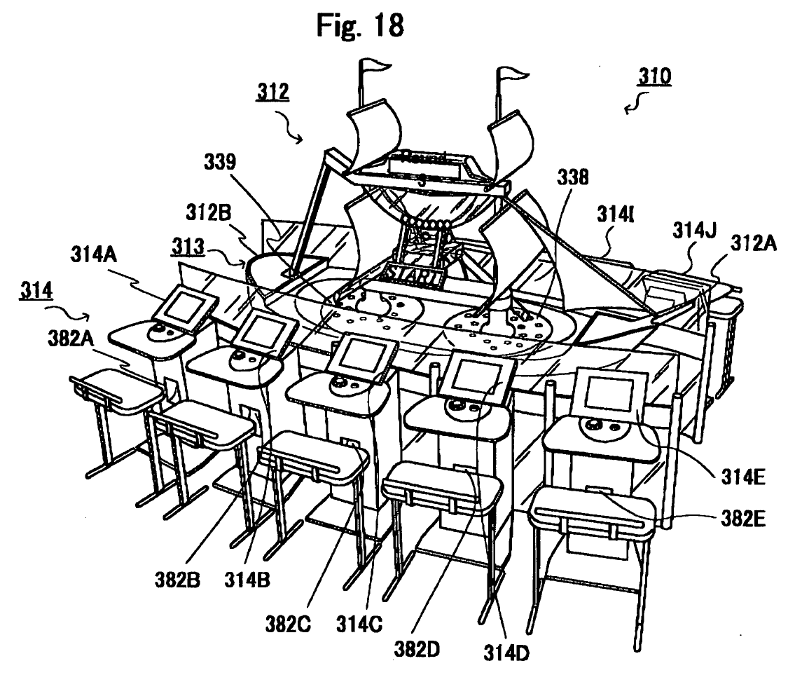

First, the outline of the gaming machine will be described with reference to FIG. 18. FIG. 18 is a perspective view showing the general view of the gaming machine according to the present invention.

As shown in FIG. 18, a gaming machine 310 comprises a lottery machine 312, and a plurality of gaming terminals 314. The gaming machine 310 can supply a game to a plurality of game players by a plurality of gaming terminals 314A to 314J at the same time.

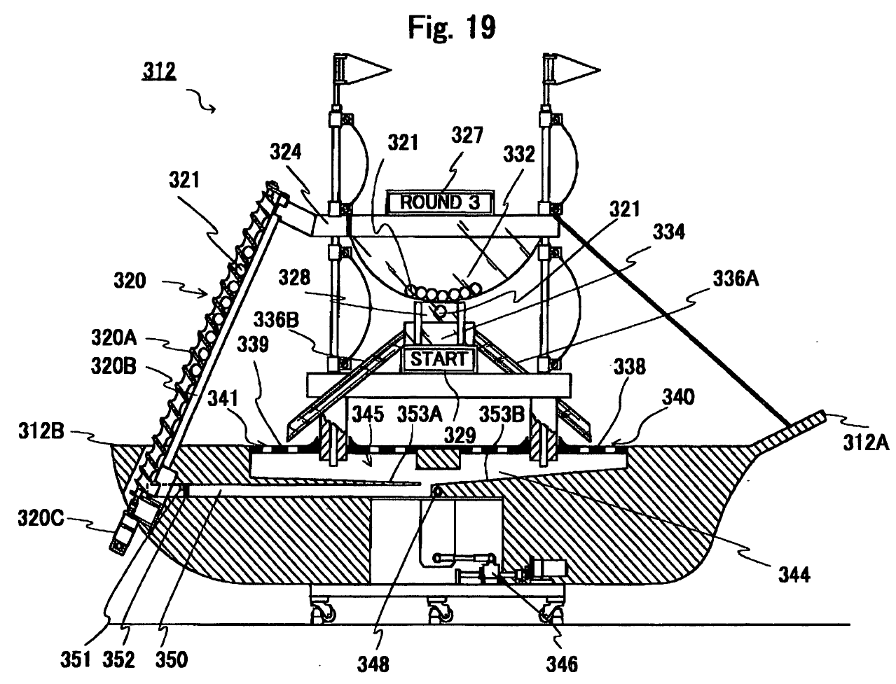

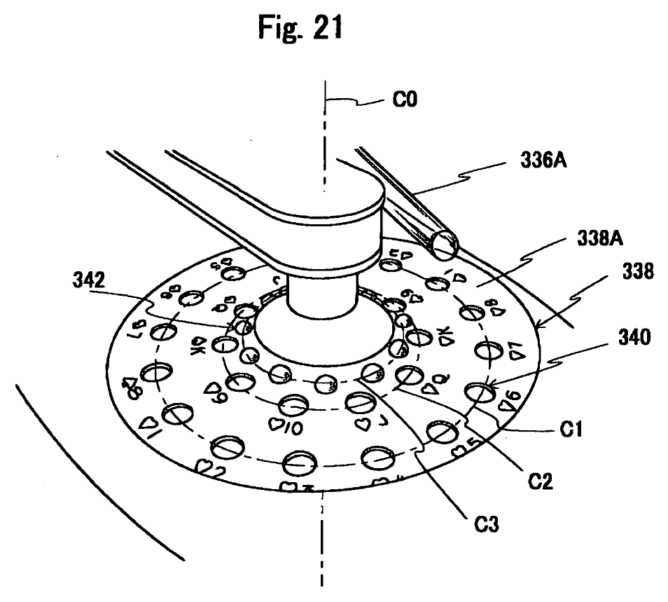

The lottery machine 312 is mainly constructed by a cabinet 313 in the form of a ship, and disposed at the center of the gaming machine 310. Two lottery boards 338 and 339 are disposed at the center of the lottery machine 312. A total of fifty two lottery holes 340 are formed in the two lottery boards 338 and 339 (see FIG. 21). The plurality of lottery holes 340 are associated with identification information comprising combinations of first symbols composed of spades, clubs, hearts and diamonds and second symbols composed of numerals of 2 to 10 and marks of A, J, Q and K. This identification information is used to determine a lottery result. That is, the identification information for determining the lottery result is associated with each of the plurality of lottery holes 340 of the lottery board 338. A lottery is carried out in accordance with any one of the plurality of lottery holes 34 which a lottery ball enters, and a game result is determined. A swinging device 346 (see FIG. 19) is provided in the lottery machine 312, and the cabinet 31 is swingable so that the stem 312A and the stem 312B are displaced in the vertical direction. That is, the swinging device 346 tilts the cabinet 313. In this embodiment, the cabinet 313 can be tilted within about ±8 degrees in the vertical direction with respect to the horizontal plane, however, the tilt angle is not limited to 8 degrees. The swinging operation of shifting from the state where the cabinet is located at the upper position of about 8 degrees with respect to the horizontal plane to the state where the cabinet is located at the lower position of about 8 degrees with respect to the horizontal plane requires a time of about 12 seconds. However, this swinging operation time is not limited to 12 seconds, but it may be preferably set in the range from about 8 seconds to about 18 seconds. Specifically, this swinging period can be controlled by a main control circuit which is similar to that of the first embodiment, and it may be changed by a manager of a game place or the like. Furthermore, in this embodiment, the swingable ship-type cabinet 313 is used, and thus a visual representation effect can be given to game players so that enjoyment of the game can be enhanced.

The plurality of gaming terminals 314A to 314J are disposed at both the stroke-side and bow-side of the lottery machine 312. In this embodiment, ten gaming terminals 314A to 314J are provided as shown in FIG. 18. Furthermore, medal payout ports 382A to 382J are formed in the plurality of gaming terminals 314A to 314J, respectively. In FIG. 18, gaming terminals 314F to 314H and medal payout ports 382F to 382J which are hidden by the lottery machine 312 are not illustrated.

In this embodiment, the ten gaming terminals 314A to 314J are equipped as the plurality of gaming terminals. However, the present invention is not limited to this. For example, a plurality of gaming terminals whose number of machines is not equal to ten may be equipped, and only one gaming terminal may be equipped.

[Construction of Lottery Machine]

The outline of the lottery machine 312 of the gaming machine 310 will be described with reference to FIG. 19. FIG. 19 is a longitudinally-sectional view showing the general view of the lottery machine 312 according to this embodiment.

As shown in FIG. 19, a screw conveyor 320 serving as a feeding unit is disposed at the stem 312B of the lottery machine 312. The screw conveyor 320 is a device for upward feeding lottery balls 321 used for the lottery through the inside of the lottery machine 312. The lottery ball 321 of this embodiment is designed to have a diameter of about 60 millimeters, however, it may be designed in another style. For example, the diameter of the lottery ball 321 may be set to not less than about 60 millimeters. Furthermore, it is preferable that the lottery ball 321 is formed of a material through which an infrared ray is not transmitted or which is processed so that an infrared ray is not transmitted therethrough, and also it is easily detected by various kinds of sensors such as an optical sensor, etc.

The screw conveyor 320 comprises a spiral member 320A which extends upward so as to be inclined at a predetermined angle, a support plate 320B extending along the spiral member 320A, and a lottery ball raising motor 320C for rotating the spiral member 320A. A groove which has a radius of curvature larger than the radius of the lottery balls 321 and designed in a spiral form is equipped to the spiral member 320A. By driving the lottery bell raising motor 320C, the spiral member 320A is rotated, and the lottery balls 321 are upward fed while being held between the spirally-formed group in the spiral member 320A and the support plate 320B. That is, the screw conveyor 320 is disposed at the outside of the cabinet 313, and carries the lottery balls 321 so that the lottery balls 321 are visible.

One end of a lottery ball guide unit 324 is disposed at the upper end of the screw conveyor 320. A guide passage (not shown) is formed in the lottery ball guide unit 324. The lottery ball guide unit 324 guides through the guide passage lottery balls 321 carried by the screw conveyor 320.

A lottery ball holding unit 332 is disposed at the upper side of the lottery machine 312. The lottery ball holding unit 332 is formed of resin having a light-transmissible property so that it can be viewed by game players, etc. Therefore, the remaining number of lottery balls 321 can be indicated to game players. The lottery ball holding unit 332 is designed to be opened at the upper portion thereof, and holds lottery balls 321 guided from the lottery ball guiding unit 324. Furthermore, an opening (not shown) through which one lottery ball 321 is passed is formed in the bottom surface of the lottery ball holding unit 332.

A cylindrical rotator 328 as a throw-in portion is disposed at the lower side of the lottery ball holding unit 332. The rotator 328 has a function of closing the opening formed in the bottom surface of the lottery ball holding unit 332. Accordingly, the lottery balls 321 held in the lottery ball holding unit 332 are kept to be held.

A holding hole (not shown) for holding one lottery ball 321 is formed in the rotator 328. A driving unit (not shown) comprising a rotating motor 326 (see FIG. 27) or the like is disposed at the edge of the rotator 328. The rotator 328 is rotated by driving the driving unit. By rotating the rotator 328, the holding hole is kept to be opened upward, and one ball held in the lottery ball holding unit 332 is made to drop through the opening to the holding hole. By further rotating the rotator 328, the opening formed in the lottery ball holding unit 332 is closed and also the one lottery ball 321 is kept to be held in the holding hole. By further rotating the rotator 328, the opening formed in the lottery ball holding portion 332 is closed and also the holding hole is set to be opened downward, so that the one lottery ball 321 held in the holding hole is made to drop downward. As described above, one lottery ball 321 held in the lottery ball holding unit 332 is extracted and drops downward. That is, the rotator 328 has a function of throwing a lottery ball 321 carried by the screw conveyor 320 from the upper side to the face portions 338A and 339A. The rotator 328 is formed of a resin having light-transmissible property, so that the lottery ball 321 held in the holding hole is kept visible to game players. Therefore, the advance of the game can be indicated to the game players.

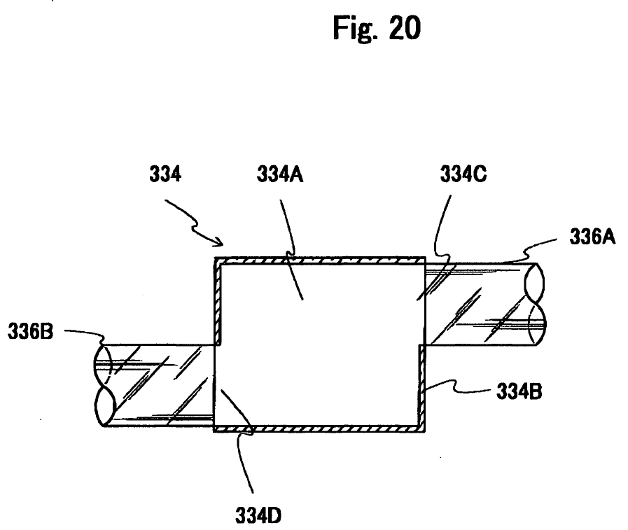

A lottery ball receiving portion 334 having transparency is disposed at the lower side of the rotator 328. The lottery ball receiving portion 334 receives a lottery ball 321 dropping from the holding hole of the rotator disposed at the upper side thereof. Therefore, the lottery ball 321 dropping from the holding hole of the rotator 328 is held in the lottery ball receiving portion 334 while it is kept visible to the game players. The lottery ball receiving portion 334 has two cut-out portions 334C and 334D (see FIG. 20) formed therein, and the lottery ball 321 thus received is thrown to any one of two lottery boards 338 and 339 through the cut-out portion 334C or 334D. Since the lottery machine 312 has a swinging function, the lottery ball 321 held in the lottery ball receiving portion 334 is guided to either of the two lottery boards 338 and 339 according to the tile angle thereof.

Slopes 336A and 336B having throw-in passages through which a lottery ball 321 can pass are disposed at the cut-out portions 334C and 334D (see FIG. 20) of the lottery ball receiving portion 334. The slopes 336A and 336B are used to throw the lottery ball 321 held in the lottery ball receiving portion 334 to any one of the face portions 338A and 339A. The slopes 338A and 336B are formed of resin having transparency. Therefore, the lottery ball 321 passing through the slope 336A and 336B is kept visible to the game players. As described above, the screw conveyor 320, the rotator 328, the slopes 336A and 336B, etc., enable lottery balls 321 discharged from the plurality of lottery holes 340 and 341 to be thrown to the face portions 338A and 339A of the cabinet 313 through a first withdrawing passage 344 and a second withdrawing passage 350.

The two lottery boards 338 and 339 are disposed at the lower ends of the slopes 338A and 336B. A lottery ball 321 can roll on the lottery boards 338 and 339, and the face portions 338A and 339A having a horizontal plane with respect to the cabinet 313 are provided. That is, the face portions 338A and 339A on which the lottery ball 321 similar to the lottery ball 21 of the first embodiment can roll are formed on the lottery boards 338 and 339, and a plurality of lottery holes 340 and 341 are formed on the upper surfaces of the face portions 338A and 339A. In other words, the cabinet 313 is equipped with the plurality of lottery boards 338 and 339, and thus it has the face portions 338A and 339A on which the lottery balls 321 can roll, and the plurality of lottery holes 340 and 341 provided on the face portions 338A and 339A Furthermore, the two lottery boards 338 and 339 can be rotated horizontally with respect to the upper surfaces of the face portions 338A and 339A.

The plurality of lottery holes 340 and 341 for holding one lottery ball 321 are formed on the upper surfaces of the face portions 338A and 339A. These plurality of lottery holes 340 and 341 are designed in such depth that about two-fifth part of one lottery hole projects from each lottery hole (similarly with the embodiment of the first embodiment (FIG. 3C)). Therefore, a lottery ball 321 entering each of the plurality of lottery holes 340 and 341 is held so as to be visible to game players, and a subsequent throw-in lottery ball 321 collides with lottery balls held in the plurality of lottery holes 340 and 341 and changes its rolling direction. Of course, according to the rotation of the lottery boards 338 and 339, the lottery balls 321 entering these lottery holes 340 and 341 are rotated while being held in the plurality of lottery holes.

A shutter 347 is provided at the bottom surfaces of the plurality of lottery holes 340 and 341. In this game, the shutter 347 is controlled to a close state, so that lottery balls 321 entering the plurality of lottery holes 340 and 341 are held. After the game is completed, the shutter 347 is controlled to an open state, so that the lottery balls 321 entering the plurality of lottery holes 340 and 341 are discharged into the lottery machine 312. Furthermore, a ball entrance detecting sensor 349 is provided to each of the plurality of lottery holes 340 and 341. The ball entrance detecting sensor 349 detects that a lottery ball 321 enters each of the plurality of lottery holes. Describing in detail later, under the condition where a lottery ball 321 enters any one of the plurality of lottery holes 340 and 341 on the lottery boards 338 and 339, identification information corresponding to the lottery hole which the lottery ball 321 enters is selected, and a game result is determined on the basis of the identification information thus selected. That is, under the condition where a lottery ball 321 enters any one of the plurality of lottery holes 340 and 341, the game result is determined on the basis of the identification information associated with any one of the plurality of lottery holes 340 and 341 which the lottery ball 321 enters. In this embodiment, one ball entrance detecting sensor 349 is equipped to each of the plurality of lottery holes 340 and 341, however, a plurality of ball entrance detecting sensors may be equipped to each of the plurality of lottery holes in order to immediately detect the entrance of the lottery ball 321. Furthermore, in order to reduce the working load and the cost in the manufacturing process, the ball entrance detecting sensor is not necessarily required to be equipped for every lottery hole. That is, the entrance of lottery balls 321 to a plurality of lottery balls 321 may be detected by using one the prize-winning detection sensor. For example, two prizewinning detecting sensors for detecting prize-winning entrance of lottery balls 321 in lottery holes through one revolution of the lottery board are used, and it is detected by the detecting sensors whether the lottery balls 321 enter the prize-winning lottery holes every time the lottery board makes a half revolution.

A withdrawing unit 345 having a first withdrawing passage 344 and a second withdrawing passage 350 is provided below the two lottery boards 338 and 339 of the lottery machine 312 as described above. The withdrawing unit 345 receives lottery balls 321 entering a plurality of lottery holes 340 and 341 in the first withdrawing passage 344 by controlling the shutter 347 to the open state, Furthermore, the withdrawing unit 345 is equipped with slant portions 353A and 353B for making the lottery balls 321 received in the first withdrawing passage 344 drop downward. Still furthermore a second withdrawing passage 350 extending in the horizontal direction is formed below the slant portions 353A and 353B. Accordingly, the lottery balls 321 entering the plurality of lottery holes 340 and 341 are guided through the first withdrawing passage 344 to the second withdrawing passage 350, and held therein. That is, the first withdrawing passage 344 and the second withdrawing passage 350 are equipped to the cabinet 313, and allow the lottery balls 321 discharged from the a plurality of lottery holes 340 and 341 to pass therethrough.

An open/close gate 352 is equipped to the second withdrawing passage 350. The open/close gate 352 is controlled to be freely opened/closed. Therefore, when the open/close gate 352 is set in an open state, lottery balls 321 are allowed to pass between the second withdrawing passage 350 and the lower end of the spiral member 320A. On the other hand, when the open/close gate 352 is set in a close state, the lottery balls 321 are prohibited from passing between the second withdrawing passage 350 and the lower end of the spiral member 320A. As described above, when the lottery machine 312 is swung so that the stern 312B side is lower than the stem 312A and the open/close gate 352 is controlled to the open state, the lottery balls 321 held in the second withdrawing passage 350 are guided to the lower end of the spiral member 320A. Furthermore, by controlling the open/close gate 352 to the close state, the lottery balls 321 guided to the lower end of the spiral member 320A are prevented from returning back to the second withdrawing passage 350, and also the lottery balls 321 held in the second withdrawing passage 350 are prevented from being guided to the lower end of the spiral member 320A.

A lottery bell passage detecting sensor 351 is disposed between the open/close gate 352 and the lower end of the spiral member 320A. The lottery ball passage detecting sensor 351 detects the number of lottery balls 321 which are guided from the second withdrawing passage 350 through the open/close gate 352 to the lower end of the spiral member 320A. Accordingly, when the lottery machine 312 is tilted so that the stern 312B side is lower than the stem 312A and also the open/close gate 352 is controlled to the open state so that a predetermined number of lottery balls 321 pass through the open/close gate 352, the open/close gate 352 is controlled to the close state, and a predetermined number of lottery balls 321 are guided to the lower end of the spiral member 320A. Furthermore, after the predetermined number of lottery balls 321 are guided to the lower end of the spiral member 320A, these lottery balls 321 are prevented from returning back to the second withdrawing passage 350.

The lottery machine 312 is equipped with the swinging device 348, and it can be swung and tilted around the swinging shaft 348.

Furthermore, a dot LED display device 327 comprising a plurality of LEDs or the like is disposed above the lottery ball holding unit 332. A round number of the game is displayed on the dot LED display device 327. A START lamp 329 is disposed at the center of the lottery machine 312. In the START lamp 329, a built-in lamp is turned on when a lottery ball 321 drops from the holding hole of the rotator 328 to the lottery ball receiving portion 334, and letters “START” are displayed to be visible to the game players. Furthermore, the gaming machine 310 may be equipped with a plurality of illumination devices (not shown) so that the sailboat type lottery machine 312 is lit up with various colors and various representations are enabled in combination with the swing operation.

[Description of Lottery Ball Receiving Portion, etc.]

The lottery ball receiving portion 334 and the slopes 336A and 336B will be described. FIG. 20 is a top view showing the lottery ball receiving portion 334 and the slopes 336A and 336B.

As shown in FIG. 20, a recess portion 334A is formed in the lottery ball receiving portion 334 described above. The recess portion 334A receives a lottery ball 321 dropping from the holding hole of the rotator 328 described above, Two cut-out portions 334C and 334D are formed at the side surfaces 334B of the lottery ball receiving portion 334. Therefore, a lottery ball 321 received in the recess portion 334A is rolled from any one of the two cut-out portions 334C and 334D to the outside of the recess portion 334A by swinging the lottery machine 312.

The upper ends of the slopes 336A and 336B are disposed at the cut-out portions 334C, 334D. As described above, the lower ends of the slopes 336A and 336B are disposed above the lottery boards 338 and 339, Therefore, the slope 336A and 336B accepts a lottery ball 321 having rolled from the cut-out portion 334C and 334D to the outside of the lottery ball receiving portion 334, and guides it to either the lottery board 338 or 339. These slopes 336A and 336B are disposed so that the lottery ball 321 is thrown in the same direction as the rotational direction of the lottery board 338 and 339. in this embodiment, the slopes 336A and 336B are linearly formed. However, they may not be formed linearly, but may be designed in a curved-shape.

[Description of Lottery Board, etc.]

The lottery machine 312 and the lottery boards 338 and 339 described above will be described with reference to FIG. 21.

FIG. 21 is a perspective view showing the lottery board 338. The lottery board 338 has the same construction as the lottery board 338, and thus the drawing and description thereof are omitted.

As shown in FIG. 21, the two lottery boards 338 and 339 are disposed in the lottery machine 312. The two lottery boards 338 and 339 can be provided with a plurality of lottery holes 340 and 341. Therefore, as compared with a case where only one lottery board is used, the setup space at a game place can be effectively used with no wasteful space because many lottery holes are provided. Accordingly, many lottery holes can be provided, and enhancement in the enjoyment of by expanding payouts, etc., can be performed.

In the case of such a conventional gaming machine that a lottery ball is extracted from a plurality of lottery balls allocated with identification information by lottery and a game result is determined on the basis of the identification information allocated to the lottery ball thus extracted (so-called lottery ball extraction type), fifty-two lottery balls are needed. In this construction, it is not easy to advance the game while making game players recognize desired lottery balls from many lottery balls, and a process which results in that a lottery ball is extracted is omitted. Therefore, game performance which makes the game players feel impatient and gives a sense of anticipation to game players may be lost, and also enjoyment of the game may be lost. On the other hand, in the case of a roulette board type gaming machine like the present invention, fifty two or more lottery holes are needed to implement a bingo game using a poker game. Particularly when one lottery board is used, the size of the lottery board is designed in a large size. Therefore, not only is the space of the game place wasted, but also it is hard for game players to visually recognize the game result, which may lose enjoyment of the game.

Therefore, by using the two lottery boards, the wasteful space for disposing the large lottery board can be omitted. There will be described a case where one circular lottery board is used and a case where two circular lottery boards are used. Substantially the same number of lottery holes can be provided by equalizing the total circumference length of the lottery board (lottery boards) between the case where only one circular lottery board is used and the case where two circular lottery boards are used. When the two circular lottery boards are used, the radius of each lottery board can be reduced to a half of the radius of the lottery board when the one circular lottery board is used. Therefore, when the two circular lottery boards are used, the total area of the lottery boards can be reduced. By using the plurality of lottery boards as described above, enjoyment of the game can be prevented from being lost without wasting the space of the game place. Furthermore, by providing a plurality of lottery holes along a plurality of circumferences, enjoyment of the game can be prevented from being lost without wasting the space of the game place.

These lottery boards 338 and 339 are designed in a circular shape from the upper side view. The lottery boards 338 and 339 are freely rotatably disposed on the deck board of the cabinet 313. Furthermore, the rotational speed of the lottery board 338 is normally set to 8 to 12 seconds per revolution, however, it may be controlled by a main control circuit 400 described later. For example, the rotational speed may be variably set to 5 to 12 seconds per revolution. In this embodiment, the lottery boards 338 and 339 are trochoidally rotated by lottery board rotating motors 335 and 337 located at the centers of the lottery boards 338 and 339. However, the driving force for rotation may be transmitted from the outer periphery, the bottom surface or other places. The face portions 338A and 339A for allowing lottery balls to roll are formed in the lottery boards 338 and 339. The lottery boards 338 and 339 are rotated in substantially the same directions as the directions in which lottery balls are thrown in from the slopes 336A and 336B. Specifically, the lottery board 338 is rotated clockwise, and the lottery ball on the slope 336A is thrown in the clockwise direction. Therefore, when the lottery ball is rolled on the lottery board 338 and 339, the speed thereof is not reduced remarkably. Accordingly, the probability that a lottery ball enters any one of the lottery holes 340 and 341 in an extremely short time is low. The lottery can be performed while the speed of the lottery ball thrown in from the slope 336A and 336B is prevented from being varied due to rotation of the lottery board 338 and 339. This is because there can be provided a non-uniform game in which by throwing in a lottery ball at a predetermined speed when the plurality of lottery holes 340 and 341 provided to the lottery boards 338 and 339 are not rotated, that is, the plurality of lottery holes 340 and 341 are not displaced, it is easy or difficult for the lottery ball to enter any one of the plurality of lottery holes 338 and 339.

Furthermore, a link table is provided between the lottery boards 338 and 339. The link table has a face horizontal to the face portions 338A and 339A of the lottery boards 338 and 339. Therefore, the lottery ball 321 can roll between the lottery boards 338 and 339. Furthermore, according to the tilt (swing) motion of the cabinet 313, the lottery ball is rolled over the plurality of lottery boards 338 and 339. The rolling speed of the lottery ball is not remarkably reduced.

Guide portions are provided between the lottery boards 338 and 339. These guide portions are located along the outer peripheries of the lottery boards 338 and 339 so as to sandwich the link table therebetween. These guide portions are designed in a convex-shape with respect to the face portions 338A and 339A of the lottery boards 338 and 339. Therefore, the roiling of the lottery ball is guided by the guide portions while the lottery ball collides with the guide portions.

Furthermore, bank portions are provided on the outer sides of the lottery boards 338 and 339. The bank portions are provided along the outer peripheries of the lottery boards 338 and 339. These bank portions are designed in a convex-shape with respect to the face portions 338A and 339A of the lottery boards 338 and 339. That is, the bank portions which are located at a higher position than the upper surfaces of the face portions 338A and 339A are disposed along the outer peripheries of the face portions 338A and 339A. Therefore, even when a lottery ball 321 thrown from the slope 336A and 336B to the lottery board 338 and 339 is rolled to the outside of the lottery board 338 and 339, the lottery ball 321 runs upon the bank portion and then rolls onto the lottery board 338 and 339 again. The traveling way of the lottery ball 321 running upon the lottery board 338 and 339 is varied according to the speed and direction of the lottery ball 321 when it runs upon the lottery board 338 and 339, and this supplies the game players with an unpredictable game, thereby enhancing enjoyment of the game. Of course, the lottery ball 321 is forced to roll to the lottery board 338 and 339, and thus the speed of the lottery ball 321 traveling to the lottery board 338 and 339 is not remarkably reduced, Furthermore, when the lottery ball 321 running upon the bank portion rolls onto the lottery board 338 and 339, the speed thereof is not remarkably reduced. Therefore, when the lottery ball 321 running upon the bank portion rolls onto the lottery board 338 and 339, the speed thereof is not remarkably reduced. Accordingly, the probability that the lottery ball 321 enters any one of the lottery holes 340 and 341 in an extremely short time is low, and the lottery ball 321 enters any one of the lottery holes 340 and 341 in a time frame from about 10 seconds to 30 seconds.

As indicated by arrows B1 and B2, the lottery boards 338 and 339 are rotated in the opposite directions. Therefore, the lottery ball 321 thrown to the lottery board 338 may roll from the lottery board 338 through the link table to the lottery board 339. Conversely, the lottery ball 321 thrown to the lottery board 339 may roll from the lottery board 339 through the link table to the lottery board 338. Accordingly, since the swinging device 346 is equipped to the lottery machine 312, there can be provided a novel game in which the cabinet 313 of the lottery machine 312 is swung and the lottery ball 321 rolls on the lottery boards 338 and 339 so that its rolling orbit between the lottery boards 338 and 339 forms a FIG. 8 and which is unpredictable to game players. Therefore, enjoyment of the game can be enhanced. The lottery boards 338 and 339, the link table, the guide portions and the bank portions are surrounded by a fence formed of a transparent resin material, whereby the lottery balls 321 are prevented from rolling to the outside of the fence.

Twenty-six lottery holes 340 and 341 are equipped to each of the lottery boards 338 and 339. Identification information comprising first symbols of spades and hearts is allocated to the plurality of lottery holes 340 provided to the lottery board 338 as shown in FIG. 21. Specifically, A, 2 to 10, J, Q, K of spades and A, 2 to 10, J, Q, K of hearts are allocated to the plurality of lottery holes 340 provided to the lottery board 338. Furthermore, identification information comprising first symbols of clubs and diamonds is allocated to the plurality of lottery holes 341 provided to the lottery board 339. Specifically, A, 2 to 10, J, Q, K of clubs and A, 2 to 10, J, Q, K of diamonds are allocated to the plurality of lottery holes 341 provided to the lottery board 339. That is, some of the plurality of symbols are set of the same type, and thus a game player is allowed to easily identify his/her desired identification information by watching a lottery-ball rolling place, so that the game player is made to feel further impatient and experiences an enhanced sense of anticipation, thereby enhancing enjoyment of the game. For example, when a lottery ball 321 rolls on the lottery board 338, the game player can easily recognize that the first symbols are clubs and diamonds. That is, identification information in which some of the first symbols are the same type of symbols is allocated to the plurality of lottery holes 340 and 341 of the two load boards 338 and 339. Accordingly, by visually recognizing the lottery board 338 and 339 on which the lottery ball 321 rolls, the game player can easily recognize his/her identification information, so that the game player is made to feel further impatient and experienced an enhanced sense of anticipation, thereby enhancing enjoyment of the game.

The plurality of lottery holes 340 are provided along the circumferences C1 and C2 around the center point C0 of the rotation on the lottery board 338. The circumference C2 is located inside of the circumference C1. Specifically, sixteen lottery holes are provided along the circumference C1, and ten lottery holes are provided along the circumference C2. That is, the plurality of lottery holes 340 and 341 are formed along the plurality of kinds of circumferences around the rotational center on the face portions 338A and 339A. As described above, the A, 2 to 10, J, Q, K of spades and A, 2 to 10, J, Q, K of hearts are allocated to the twenty six lottery holes 340. Specifically, A, 2 to 8 of spades and A, 2 to 8 of hearts are allocated to the sixteen lottery holes provided along the circumference C1, and 9, 10, J, Q, K of spades and 9, 10, J, Q, K of hearts are allocated to the ten lottery holes provided along the circumference C2.

Furthermore, as shown in FIG. 21, a plurality of projecting portions 342 each having a convex shape with respect to the face portion 338A of the lottery board 338 are provided on the lottery board 338. These plurality of projecting portions 342 are provided along a circumference C3 around the center point C0 of the rotation. The circumference C3 is located at the inside of the innermost circumference C2 of the circumferences C1 and C2 on which the plurality of lottery holes are provided. That is, the plurality of projecting portions 342 are provided along the circumference C3 at the inside of the innermost circumference C2 of the plurality of kinds of the circumferences C1 and C2 so as to be adjacent to the plurality of lottery holes formed on the innermost circumference C2. Accordingly, for example, a lottery ball 321 collides with some projecting portion to weaken its rolling power and vary its rolling direction, so that the lottery ball 321 can equally enter any one of the lottery holes formed along the inner circumference C2 and the lottery holes formed along the outer circumference C1. Therefore, the lottery can be performed so that a lottery ball 321 can equally enter any one of many lottery holes.

Furthermore, it is preferable that each of the convex-shaped projecting portions 342A may be provided in an area surrounded by the circumference C3 and the tangent rows of adjacent two lottery holes 340A and 340B located along the inner circumference C2. For example, a lottery ball 321 passing between the lottery holes 340A and 340B impinges a projecting portion 342A to weaken the rolling power thereof and vary the rolling direction thereof, so that the lottery ball enters any one of the lottery holes 340A, 340B with higher probability. Furthermore, the lottery ball equally enters any one of the lottery holes formed along the outer circumference C1 and the lottery holes formed along the inner circumference C2 of the plurality of kinds of circumferences C1 and C2, and thus the lottery can be performed so that a lottery ball can equally enter many lottery holes. Furthermore, the identification information may be controlled by the main control circuit 400 described later and also changed by the manager of the game place or the like. Of course, marks indicating the identification information corresponding to the plurality of lottery holes 340 and 341 formed on the face portions 338A and 339A are indicated in the vicinity of the plurality of lottery holes 340 and 341. The marks indicating the identification information may be changed by replacing the lottery boards 338 and 339.

[Description of Withdrawing Unit]

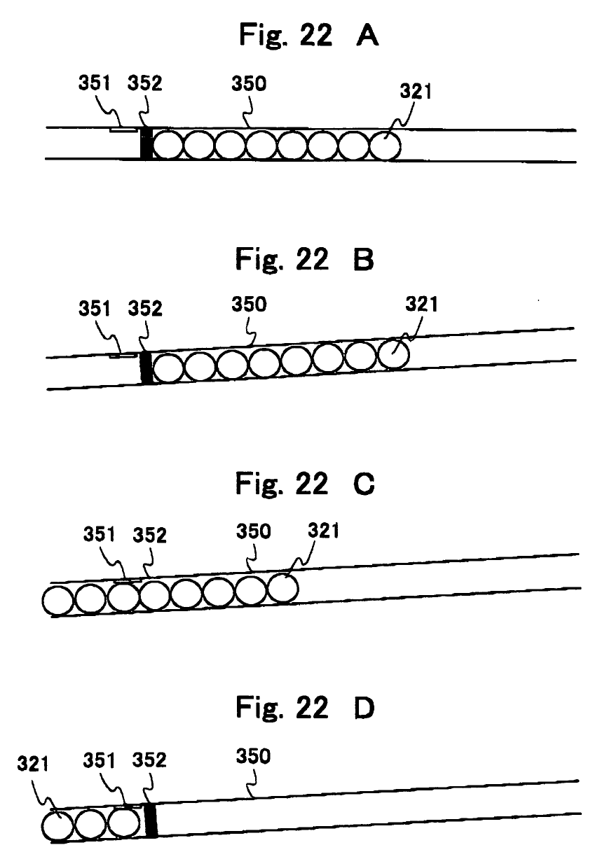

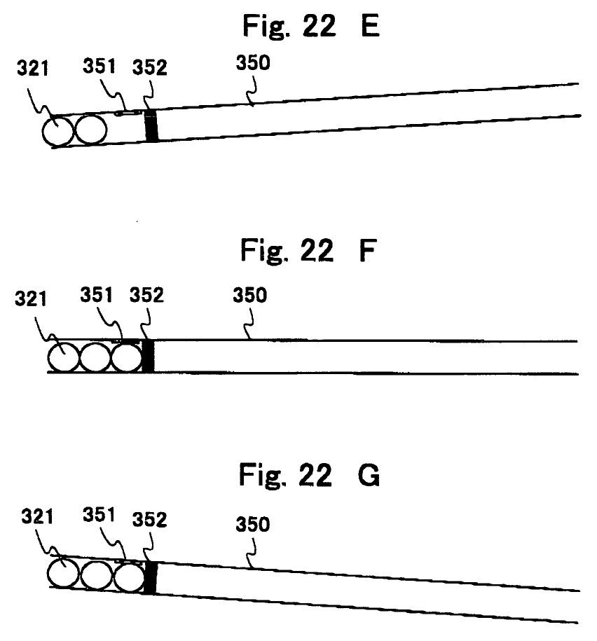

The withdrawing unit 345 of the lottery machine 312 will be described with reference to FIGS. 22A to 22G. FIGS. 22A to 22G are longitudinally-sectional views showing a second withdrawing passage 350.

After a game is finished, the shutter 347 is set in the open state as described above, so that lottery balls 321 drop from a plurality of lottery holes 340 and 341. After a predetermined period of time elapses, these lottery balls 321 are passed through the first withdrawing passage 344 and held in the second withdrawing passage 350 as shown in FIG. 22A. As shown in FIG. 22A, the cabinet 313 is tilted by the swinging device 346 under the state where the lottery balls 321 are held in the second withdrawing passage 350 of the withdrawing portion 345 described above. In this case, the open/close gate 352 provided to the second withdrawing passage 350 is set in the close state as shown in FIG. 22B, and thus the lottery balls 321 are held in the second withdrawing passage 350 so as to be located at the open/close gate 352 side.

Then, by controlling the open/close gate 352 to the open state as shown in FIG. 22C, the lottery balls 321 located in the second withdrawing passage 350 roll to the lower side of the spiral member 320A. That is, the cabinet 313 is titled and the lottery balls 321 located in the second withdrawing passage 350 are guided to the screw conveyor 320. When the lottery balls 321 roll to the lower side of the spiral member 320A as described above, the number of the lottery balls 321 roiling to the lower side of the spiral member 320A is detected by the lottery ball passage detecting sensor 351. That is, the lottery ball passage detecting sensor 351 detects the number of the lottery balls 321 guided from the second withdrawing passage 350 to the screw conveyor 320. In other words, the lottery ball passage detecting sensor 351 detects the number of the lottery balls 321 passing through the open/close gate 352. When the number of the lottery balls 321 detected by the lottery ball passage detecting sensor 351 reaches a predetermined number, the open/close gate 352 is controlled to be the close state as shown in FIG. 22D. Accordingly, as shown in FIG. 22E, the predetermined number of lottery balls 321 roll to the lower side of the spiral member 320A, and then are upward fed by the screw conveyor 320. That is, these lottery balls 321 are set in a throw-in possible state. Under this state, the cabinet 313 is controlled so that the tilted state thereof is returned to the horizontal state as shown in FIG. 22F, that is, the tilt motion thereof is controlled to stop That is, the swinging device 346 has a function of stopping the tilting motion of the cabinet 313. Furthermore, as shown in FIG. 22F, the lottery balls 321 rolling to the lower side of the spiral member 320A are prevented from returning back. Of course, even when the cabinet is tilted in the opposite direction as shown in FIG. 22G, the lottery balls 321 rolling to the lower side of the spiral member 320A are prevented from returning back.

Accordingly, since the cabinet 313 (see FIG. 18) can be titled and the lottery balls 321 located in the second withdrawing passage 350 can be guided to the lower side of the spiral member 320A. the lottery balls 321 can be withdrawn by merely tilting the cabinet 313, and thus the gaming machine can be manufactured simply and at a low cost. Particularly with a large-size gaming machine such as a bingo game or the like, it is required to save the space even if only slightly, and the space can be further saved according to the present invention. Furthermore, it is not required to provide the lottery ball discharging means to each of the plurality of lottery holes, and thus the gaming machine can be manufactured more simply and at a lower cost.

The effects described in this specification are merely examples of the most preferable effects achieved by the present invention, and thus the effects of the present invention are not limited to those described in this specification.

As described above, the actual lottery balls are set to be visible to game players, and thus various information such as the number of lottery balls, lottery holes which lottery balls are being put in, etc., can be set to be visually recognizable. Therefore, there can be provided a gaming machine which effects game players with realistic sensations.

1. A gaming machine comprising:
a cabinet having a face portion on which a lottery ball rolls and a plurality of lottery holes provided on the face portion, and
game result determination means for determining a game result on a basis of each of the plurality of holes receiving a lottery ball under a condition that the lottery ball enters any one of the plurality of lottery holes, further comprising:
lottery ball throwing means for throwing a plurality of lottery balls onto the face portion of the cabinet;
ball entrance detecting means for detecting whether all the plurality of lottery balls having been thrown onto the face portion of the cabinet by the lottery ball throwing means enter any of the plurality of lottery holes; and
lottery ball discharging means for discharging the plurality of lottery balls having entered any of the plurality of lottery holes,
wherein the lottery ball discharging means has a function to discharge all the plurality of lottery balls after a predetermined period of time elapses when the ball entrance detecting means detects that all the plurality of lottery balls having been thrown by the lottery ball throwing means enter any of the plurality of respective lottery holes.

2. (canceled)

3. The gaming machine according to claim 1,
wherein symbols are allocated to respective cells of a matrix comprising two or more cell numbers of rows and two or more cell numbers of columns, the cell number of the rows are equal to the cell number of the columns, and the respective symbols are allocated to the plurality of respective lottery holes, and
wherein, when a lottery ball enters any one of the plurality of lottery holes, the game result determination means has a function to activate a cell corresponding to a symbol allocated to any one of the plurality of lottery holes which the lottery ball enters and to determine a game result in accordance with a distribution condition in the matrix containing cells having been activated as a result of entrance of the lottery ball to any one of the plurality of lottery holes for a predetermined number of times.

4. The gaming machine according to claim 1, wherein the lottery ball discharging means is provided with a shutter which is freely opened/closed on a lower side of any one of the lottery holes, and
wherein, when the ball entrance detecting means detects that all of the plurality of lottery balls having been thrown by the lottery ball throwing means enter any of the plurality of lottery holes, the lottery ball discharging means has a function to open the shutter after a predetermined period of time elapses.

5. A gaming machine being provided with a face portion on which a lottery ball rolls,
a plurality of lottery holes provided on the face portion such that the plurality of lottery balls can enter any of the plurality of lottery holes,
a sensor for detecting entrance of the plurality of lottery balls to any of the plurality of lottery holes, and
a shutter for holding the plurality of lottery balls in the plurality of lottery holes which the plurality of lottery balls have entered,
wherein a game result is determined on a basis of the lottery holes which the lottery balls enter, and
wherein the shutter is opened to discharge the lottery balls having entered the lottery holes from the lottery holes.

6. A gaming machine being provided with a face portion on which a lottery ball rolls,
a plurality of lottery holes provided on the face portion such that a plurality of lottery balls can enter any of the plurality of lottery holes,
a sensor for detecting entrance of the lottery ball to any one of the plurality of lottery holes, and
shutters for holding the plurality of lottery balls in the plurality of lottery holes which the plurality of lottery balls have entered,
wherein a game result is determined on a basis of a combination of a plurality of lottery holes which the plurality of lottery balls enter, and
the shutters are opened to discharge the plurality of lottery balls having entered from the plurality of lottery holes.

7. A program for controlling a gaming machine comprising:
a cabinet being composed of a face portion on which a lottery ball rolls and a plurality of lottery holes provided on the face portion,
game result determination means for determining a game result on a basis of each of the plurality of lottery holes which a lottery ball enters under a condition that the lottery ball enters any one of the plurality of lottery holes,
lottery ball throwing means for throwing a plurality of lottery balls onto the face portion of the cabinet,
ball entrance detecting means for detecting whether all the plurality of lottery balls having been thrown onto the face portion of the cabinet by the lottery ball throwing means enter any of the plurality of lottery holes, and
lottery ball discharging means for discharging the plurality of lottery balls having been thrown by the lottery ball throwing means and having entered any of the plurality of lottery holes,
wherein the program makes the gaming machine execute the step that the lottery ball discharging means discharges all the plurality of lottery balls having been thrown by the lottery ball throwing means after a predetermined period of time elapses when it is detected by the ball entrance detecting means that the plurality of lottery balls having been thrown by the lottery ball throwing means enter the plurality of respective lottery holes.

8. The program according to claim 7, wherein the program makes the gaming machine execute a step that the lottery ball discharging means discharges all the plurality of lottery balls having been thrown by the lottery ball throwing means after a predetermined period of time elapses when the ball entrance detecting means detects that the plurality of lottery balls having been thrown by the lottery ball throwing means enter any of the plurality of lottery holes.

9. The program according to claim 7, wherein symbols are allocated to respective cells of a matrix comprising two or more cell numbers of rows and two or more cell numbers of columns, the cell number of the row is equal to the cell number of the column, and the symbols are allocated to the plurality of respective lottery holes, and
the program makes the gaming machine execute a step of outputting to the game result determination means an instruction for controlling to activate a cell corresponding to a symbol allocated to any one of the plurality of holes which a lottery ball enters when the lottery ball enters any one of the plurality of holes, and a step of outputting to the game result determination means an instruction for controlling to determine a game result in accordance with a distribution condition of cells activated in the matrix as a result of entrance of the lottery ball to any one of the plurality of lottery holes for a predetermined number of times.

10. The program according to claim 7,
wherein the lottery ball discharging means is provided with a shutter which can be freely opened/closed on a lower side of the lottery hole, and
wherein, when the ball entrance detecting means detects that all the plurality of lottery balls having been thrown by the lottery ball throwing means enter any of the plurality of lottery holes, the program makes the gaming machine execute a step of controlling the lottery ball discharging means to open the shutter after a predetermined period of time elapses.

11. The gaming machine according to claim 1, wherein the lottery ball discharging means has a function to discharge none of the plurality of lottery balls after the predetermined period of time elapses when the ball entrance detecting means detects that not all the plurality of lottery balls having been thrown by the lottery ball throwing means enter any of the plurality of respective lottery holes.
